(19) United States
(12) Patent Application Publication
(10) Pub. No.: US 2024/0322870 A1
(43) Pub. Date: Sep. 26, 2024

(54) RESOURCE MAPPING OF FREQUENCY DOMAIN COMPRESSION BASED FREQUENCY-SELECTIVE PRECODER MATRIX

(71) Applicant: QUALCOMM Incorporated, San Diego, CA (US)

(72) Inventors: Chenxi HAO, Beijing (CN); Yu ZHANG, San Diego, CA (US); Liangming WU, Beijing (CN); Yi HUANG, San Diego, CA (US); Hao XU, Beijing (CN); Peter GAAL, San Diego, CA (US)

(21) Appl. No.: 18/697,904

(22) PCT Filed: Dec. 16, 2021
(86) PCT No.: PCT/CN2021/138809

§ 371 Date: Apr. 2, 2024

(51) Int. Cl. H04B 7/0456; H04W 72/0453

(52) U.S. Cl. CPC H04B 7/0456; H04W 72/0453

(57) ABSTRACT

A method of wireless communication performed by a user equipment (UE), the method including: receiving an indication of uplink (UL) precoding information, wherein the UL precoding information includes a set of frequency domain (FD) bases and coefficients applied to one or more antenna ports; determining a size of the FD bases based at least in part on an item selected from a list consisting of: a dedicated indication, a frequency resource allocation of an UL channel, and an UL bandwidth part (BWP); receiving a grant of a physical uplink shared channel (PUSCH), wherein a frequency resource allocation of the PUSCH includes a plurality of FD units; and determining precoding matrices for the plurality of FD units based at least in part on entries of the set of FD bases, wherein the entries correspond to positions of the FD bases in a range of a frequency resource.

### BACKGROUND

### Field of the Disclosure

Aspects of the present disclosure relate to wireless communications, and more particularly, to techniques for performing subband level precoding for uplink transmission.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

One general aspect includes a method of wireless communication performed by a user equipment (UE). The method of wireless communication also includes receiving an indication of uplink (UL) precoding information, where the UL precoding information includes a set of frequency domain (FD) bases and coefficients applied to one or more antenna ports; determining a size of the FD bases based at least in part on an item selected from a list may include of: a dedicated indication, a frequency resource allocation of an UL channel, and an UL bandwidth part (BWP); receiving a grant of a physical uplink shared channel (PUSCH), where a frequency resource allocation of the PUSCH includes a plurality of FD units; and determining precoding matrices for the plurality of FD units based at least in part on entries of the set of FD bases, where the entries correspond to positions of the FD bases in a range of a frequency resource in which the FD bases apply. Other embodiments of this aspect include corresponding computer systems, apparatus, and computer programs recorded on one or more computer storage devices, each configured to perform the actions of the methods.

One general aspect includes a non-transitory computer-readable medium having program code recorded thereon for wireless communication by a user equipment (UE). The non-transitory computer-readable medium also includes code for receiving a set of frequency domain (FD) bases and coefficients corresponding to one or more antenna ports of the UE; code for determining a size of the FD bases based at least in part on an item selected from a list may include of: a dedicated indication, a frequency resource allocation of an UL channel, and an UL bandwidth part (BWP); and code for determining precoding matrices for a plurality of FD units in a physical uplink shared channel (PUSCH) based at least in part on entries of the set of FD bases, where the entries correspond to positions of the FD bases in a range of a frequency resource in which the FD bases apply. Other embodiments of this aspect include corresponding computer systems, apparatus, and computer programs recorded on one or more computer storage devices, each configured to perform the actions.

One general aspect includes a user equipment (UE). The user equipment also includes means for receiving, from a network entity, information indicating a plurality of frequency domain (FD) bases and linear combination coefficients; means for receiving a grant of a physical uplink shared channel (PUSCH), where a frequency resource allocation of the PUSCH includes a plurality of FD units; and means for determining subband precoding based at least in part on linear combinations of the FD bases, where the subband precoding maps PUSCH layers to antenna ports of the UE, including determining a precoding matrix for each FD unit based on a respective entry of the FD bases, where the respective entry is determined based on a position of a corresponding FD basis within a range of a frequency resource of the plurality of FD bases; and means for transmitting the PUSCH with the subband pre-coding Other embodiments of this aspect include corresponding computer systems, apparatus, and computer programs recorded on one or more computer storage devices, each configured to perform the actions.

One general aspect includes a user equipment (UE) a processor configured to execute machine-readable instructions to perform a method that includes: receiving, from a network entity, information indicating a plurality of frequency domain (FD) bases and linear combination coefficients; receiving a grant of a physical uplink shared channel (PUSCH), where a frequency resource allocation of the PUSCH includes a plurality of FD units; and determining subband precoding based at least in part on linear combinations of the FD bases, where the subband precoding maps PUSCH layers to antenna ports of the UE, including determining a pre-coding matrix for each FD unit based on a respective entry of the FD bases, where the respective entry is determined based on a position of a corresponding FD basis within a range of a frequency resource of the plurality of FD bases; and transmitting the PUSCH with the subband pre-coding. Other embodiments of this aspect include corresponding computer systems, apparatus, and computer programs recorded on one or more computer storage devices, each configured to perform the actions.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram showing examples for implementing a communication protocol stack in the example RAN architecture, in accordance with certain aspects of the present disclosure.

FIG. 3 is a block diagram conceptually illustrating a design of an example base station (BS) and user equipment (UE), in accordance with certain aspects of the present disclosure.

FIG. 4 illustrates an example of a frame format for a telecommunication system, in accordance with certain aspects of the present disclosure.

FIG. 5 illustrates a conceptual example of a first precoder matrix for transmission layer O and a second precoder matrix for transmission layer 1, in accordance with certain aspects of the present disclosure.

FIG. 6 illustrates three tables showing example M values according to rank and layer, in accordance with certain aspects of the present disclosure.

FIG. 7 illustrates graphically various matrices.

FIG. 8 is a call flow diagram illustrating an example of codebook based UL transmission.

FIG. 9 illustrates an example of wideband precoding for codebook based UL transmission.

FIG. 10 is a call flow diagram illustrating an example of non-codebook based UL transmission.

FIG. 11 illustrates an example of wideband precoding for non-codebook based UL transmission.

FIGS. 12A-12F illustrate precoder matrix sets for various layer and antenna port combinations.

FIG. 13 illustrates example operations for wireless communication by a UE, in accordance with certain aspects of the present disclosure.

FIG. 14 illustrates example operations for wireless communication by a base station, in accordance with certain aspects of the present disclosure.

FIG. 15 is a call flow diagram illustrating example UL transmission with sub band precoding, in accordance with certain aspects of the present disclosure.

FIG. 16 illustrates example linear combinations of FD bases, in accordance with aspects of the present disclosure.

FIGS. 17A-17D illustrate examples scenarios for FD bases and linear combination coefficients, in accordance with aspects of the present disclosure.

FIG. 18 illustrates an example relationship between a sounding reference signal (SRS) bandwidth and a frequency domain resource allocation for a physical uplink shared channel (PUSCH), according to aspects of the present disclosure.

FIGS. 19-26 illustrate relationships between resource blocks (RBs), FD units, SRS bandwidth, and PUSCH frequency domain resource allocation, as they relate to various techniques for determining pre-coding information, according to aspects of the present disclosure.

FIG. 27 illustrates an example method performed by a user equipment (UE) according to aspects of the present disclosure.

FIG. 28 illustrates an example method performed by a network entity, such as a base station (BS), according to aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for performing subband level precoding for uplink transmission.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA cdma2000 covers IS-2000, IS-95 and IS-856 standards. A TDMA network may implement a radio technology such as Global System for Mobile Communications (GSM). An OFDMA network may implement a radio technology such as NR (e.g. 5GRA), Evolved UTRA (E-UTRA), Ultra Mobile Broadband (UMB), IEEE 802.11 (Wi-Fi), IEEE 802.16 (WiMAX), IEEE 802.20, FlashOFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

### Example Wireless Communications System

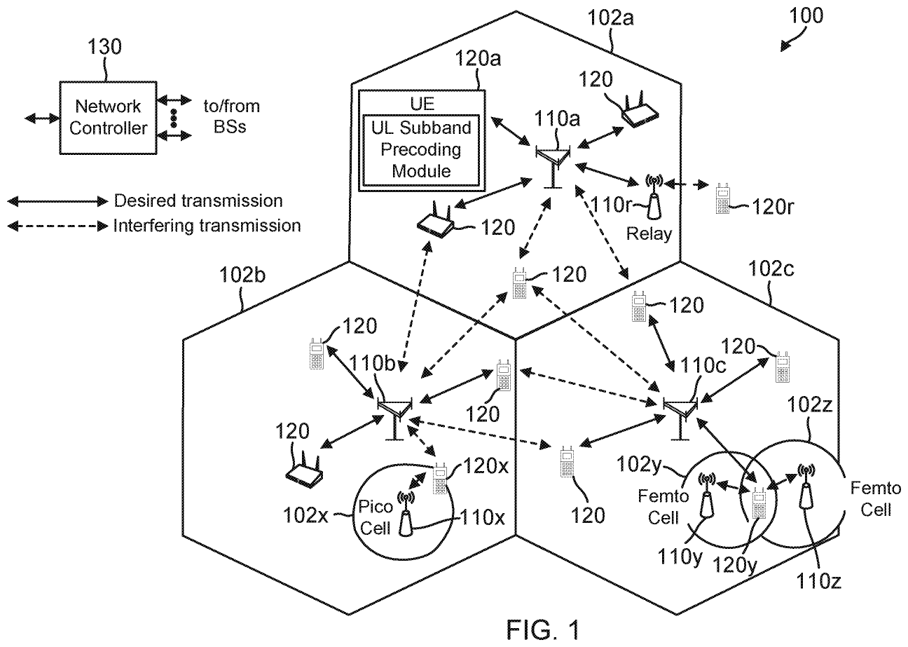

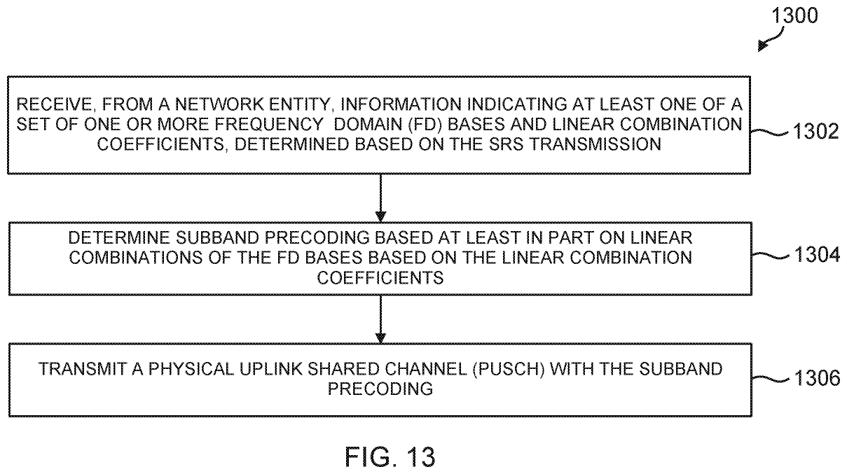

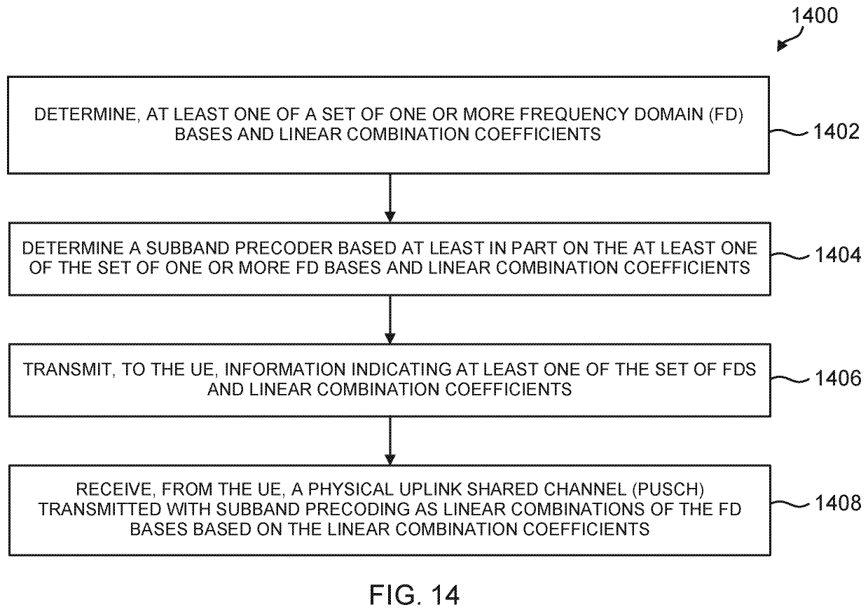

FIG. 1 illustrates an example wireless communication network 100 in which aspects of the present disclosure may be performed. For example, a UE 120 in the wireless communication network 100 may include an UL sub band precoding module configured to perform (or assist the UE 120 in performing) operations 1300 described below with reference to FIG. 13. Similarly, a base station 110 (e.g., a gNB) may include an UL sub band precoding module configured to perform (or assist the base station 110 in performing) operations 1400 described below with reference to FIG. 14.

As illustrated in FIG. 1, the wireless communication network 100 may include a number of base stations (BSs) 110 and other network entities. A BS may be a station that communicates with user equipment (UE). Each BS 110 may provide communication coverage fora particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into sub-bands. For example, a sub-band may cover 1.08 MHz (i.e., 6 resource blocks), and there may be 1, 2, 4, 8, or 16 sub-bands for system bandwidth of 1.25, 2.5, 5, 10 or 20 MHz, respectively.

Communication systems such as NR may utilize OFDM with a cyclic prefix (CP) on the uplink and downlink and include support for half-duplex operation using time division duplex (TDD). Beamforming may be supported and beam direction may be dynamically configured. Multiple-input multiple-output (MIMO) transmissions with precoding may also be supported. MIMO configurations in the downlink (DL) may support up to 8 transmit antennas with multi-layer DL transmissions up to 8 streams and up to 4 streams per UE. Multi-layer transmissions with up to 4 streams per UE may be supported. Aggregation of multiple cells may be supported with up to 8 serving cells.

In some examples, access to the a1r interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

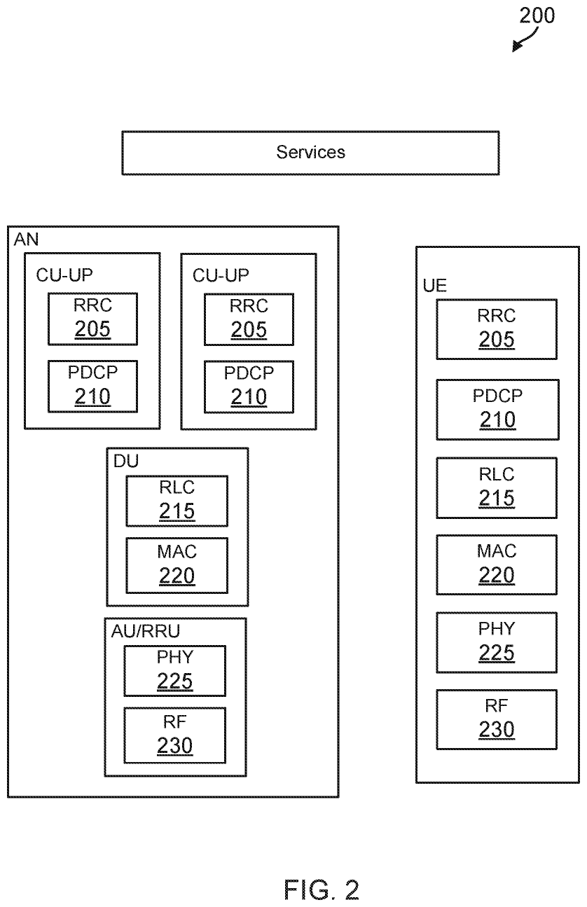

FIG. 2 illustrates a diagram showing examples for implementing a communications protocol stack in a RAN (e.g., such as the wireless communication network 100), according to aspects of the present disclosure. The illustrated communications protocol stack 200 may be implemented by devices operating in a wireless communication system, such as a 5G NR system (e.g., the wireless communication network 100). In various examples, the layers of the protocol stack 200 may be implemented as separate modules of software, portions of a processor or ASIC, portions of non-collocated devices connected by a communications link, or various combinations thereof. Collocated and noncollocated implementations may be used, for example, in a protocol stack for a network access device or a UE. As shown in FIG. 2, the system may support various services over one or more protocols. One or more protocol layers of the protocol stack 200 may be implemented by the AN and/or the UE.

As shown in FIG. 2, the protocol stack 200 is split in the AN (e.g., BS 110 in FIG. 1). The radio resource control (RRC) layer 205, PDCP layer 210, RLC layer 215, MAC layer 220, PHY layer 225, and RF layer 230 may be implemented by the AN. For example, the CU-CP may implement the RRC layer 205 and the PDCP layer 210. A DU may implement the RLC layer 215 and MAC layer 220. The AU/RRU may implement the PHY layer(s) 225 and the RF layer(s) 230. The PHY layers 225 may include a high PHY layer and a low PHY layer.

The UE may implement the entire protocol stack 200 (e.g., the RRC layer 205, the PDCP layer 210, the RLC layer 215, the MAC layer 220, the PHY layer(s) 225, and the RF layer(s) 230).

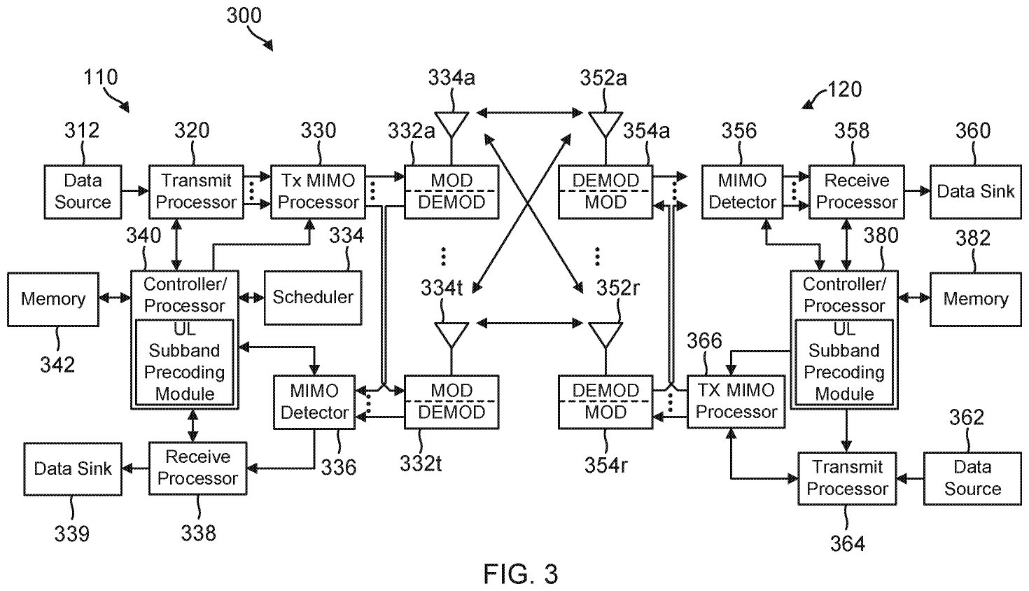

FIG. 3 illustrates example components of BS 110 and UE 120 (as depicted in FIG. 1), which may be used to implement aspects of the present disclosure. For example, antennas 352, processors 366, 358, 364, and/or controller/processor 380 of the UE 120 may be configured (or used) to perform operations 1300 of FIG. 3 and/or antennas 334, processors 320, 330, 338, and/or controller/processor 340 of the BS 110 may be configured (or used) to perform operations 1400 described below with reference to FIG. 14.

At the BS 110, a transmit processor 320 may receive data from a data source 312 and control information from a controller/processor 340. The control information may be for the physical broadcast channel (PBCH), physical control format indicator channel (PCFICH), physical hybrid ARQ indicator channel (PRICH), physical downlink control channel (PDCCH), group common PDCCH (GC PDCCH), etc. The data may be for the physical downlink shared channel (PDSCH), etc. The processor 320 may process (e.g., encode and symbol map) the data and control information to obtain data symbols and control symbols, respectively. The processor 320 may also generate reference symbols, e.g., for the primary synchronization signal (PSS), secondary synchronization signal (SSS), and cell-specific reference signal (CRS). A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) in transceivers 354a through 354r, respectively. Each demodulator 354 may condition (e.g., filter, amplify, down-convert, and digitize) a respective received signal to obtain input samples. Each demodulator may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, de-interleave, and decode) the detected symbols, provide decoded data for the UE 120 to a data sink 360, and provide decoded control information to a controller/processor 380.

In a MIMO system, a transmitter (e.g., UE 120) includes multiple transmit antennas 352a through 352r, and a receiver (e.g., BS 110) includes multiple receive antennas 334a through 334r. Thus, there are a plurality of signal paths 394 from the transmit antennas 352a through 352r to the receive antennas 334a through 334r. Each of the transmitter and the receiver may be implemented, for example, within a BS 110, a UE 120, or any other suitable wireless communication device.

The use of such multiple antenna technology enables the wireless communication system to exploit the spatial domain to support spatial multiplexing beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system is limited by the number of transmit or receive antennas, whichever is lower. In addition, the channel conditions at the UE, as well as other considerations, such as the available resources at the base station, may also affect the transmission rank. For example, the rank (and therefore, the number of transmission layers) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

On the uplink, at UE 120, a transmit processor 364 may receive and process data (e.g., for the physical uplink shared channel (PUSCH)) from a data source 362 and control information (e.g., for the physical uplink control channel (PUCCH) from the controller/processor 380. The transmit processor 364 may also generate reference symbols for a reference signal (e.g., for the sounding reference signal (SRS)). The symbols from the transmit processor 364 may be precoded by a TX MIMO processor 366 if applicable, further processed by the demodulators in transceivers 354a through 354r (e.g., for SC-FDM, etc.), and transmitted to the base station 110. At the BS 110, the uplink signals from the UE 120 may be received by the antennas 334, processed by the modulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

The controllers/processors 340 and 380 may direct the operation at the BS 110 and the UE 120, respectively. The processor 340 and/or other processors and modules at the BS 110 may perform or direct the execution of processes for the techniques described herein. The memories 342 and 382 may store data and program codes for BS 110 and UE 120, respectively. A scheduler 344 may schedule UEs for data transmission on the downlink and/or uplink.

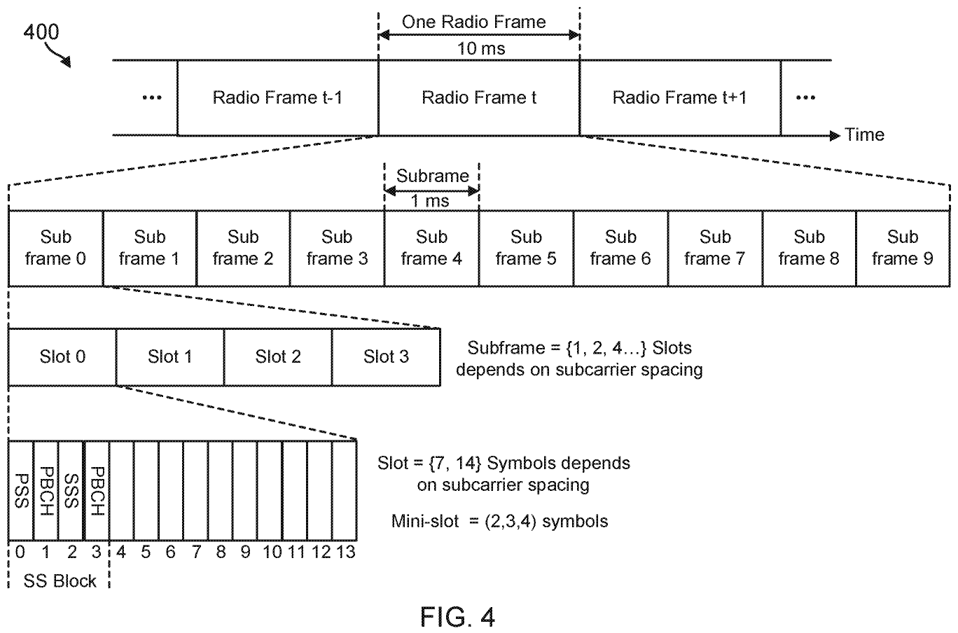

FIG. 4 is a diagram showing an example of a frame format 400 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of O through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 4. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example CSI Report Configuration

Channel state information (CSI) may refer to channel properties of a communication link. The CSI may represent the combined effects of, for example, scattering fading, and power decay with distance between a transmitter and receiver. Channel estimation using pilots, such as CSI reference signals (CSI-RS), may be performed to determine these effects on the channel. CSI may be used to adapt transmissions based on the current channel conditions, which is useful for achieving reliable communication, in particular, with high data rates in multi-antenna systems. CSI is typically estimated at the receiver, quantized, and fed back to the transmitter.

The time and frequency resources that can be used by the UE to report CSI are controlled by a base station (e.g., gNB). CSI may include Channel Quality Indicator (CQI), precoding matrix indicator (PMI), CSI-RS resource indicator (CRI), SS/PBCH Block Resource indicator (SSBRI), layer indicator (LI), rank indicator (RI) and/or LIRSRP. However, as described below, additional or other information may be included in the report.

The base station may configure UEs for CSI reporting. For example, the BS configures the UE with a CSI report configuration or with multiple CSI report configurations. The CSI report configuration may be provided to the UE via higher layer signaling, such as radio resource control (RRC) signaling (e.g., CSI-ReportConfig). The CSIreportconfiguration may be associated with CSI-RS resources for channel measurement (CM), interference measurement (IM), or both. The CSI report configuration configures CSI-RS resources for measurement (e.g., CSI-ResourceConfig). The CSI-RS resources provide the UE with the configuration of CSI-RS ports, or CSIRS port groups, mapped to time and frequency resources (e.g., resource elements (REs)). CSI-RS resources can be zero power (ZP) or non-zero power (NZP) resources. At least one NZP CSI-RS resource may be configured for CM.

For the Type II single panel codebook, the PMI is a linear combination of beams; it has a subset of orthogonal beams to be used for linear combination and has per layer, per polarization, amplitude and phase for each beam. For the PMI of any type, there can be wideband (WB) PMI and/or subband (SB) PMI as configured.

The CSI report configuration may configure the UE for aperiodic, periodic, or semi-persistent CSI reporting. For periodic CSI, the UE may be configured with periodic CSI-RS resources. Periodic CSI and semi-persistent CSI report on physical uplink control channel (PUCCH) may be triggered via RRC or a medium access control (MAC) control element (CE). For aperiodic and semi-persistent CSI on the physical uplink shared channel (PUSCH), the BS may signal the UE a CSI report trigger indicating for the UE to send a CSI report for one or more CSI-RS resources, or configuring the CSI-RS report trigger state (e.g., CSI-AperiodicTriggerState List and (SI-SemiPersistentOnPUSCH-TriggerStateList). The CSI report trigger for aperiodic CSI and semi-persistent CSI on PUSCH may be provided via downlink control information (DCI). The CSI-RS trigger may be signaling indicating to the UE that CSIRS will be transmitted for the CSI-RS resource.

The UE may report the CSI feedback based on the CSI report configuration and the CSI report trigger. For example, the UE may measure the channel associated with CSI for the triggered CSI-RS resources. Based on the measurements, the UE may select a preferred CSI-RS resource. The UE reports the CSI feedback for the selected CSI-RS resource. LI may be calculated conditioned on the reported CQI, PMI, RI and CRI; CQI may be calculated conditioned on the reported PMI, RI and CRI; PMI may be calculated conditioned on the reported RI and CRI; and RI may be calculated conditioned on the reported CRI.

Each CSI report configuration may be associated with a single downlink bandwidth part (BWP). The CSI report setting configuration may define a CSI reporting band as a subset of sub bands of the BWP. The associated DL BWP may indicated by a higher layer parameter (e.g., bwp-Id) in the CSI report configuration for channel measurement and contains parameter(s) for one CSI reporting band, such as codebook configuration, time-domain behavior, frequency granularity for CSI, measurement restriction configurations, and the CSI-related quantities to be reported by the UE. Each CSI resource setting may be located in the DL BWP identified by the higher layer parameter, and all CSI resource settings may be linked to a CSI report setting have the same DL BWP.

In certain systems, the UE can be configured via higher layer signaling (e.g., in the CSI report configuration) with one out of two possible subband sizes (e.g., reportFreqConfiguration contained in a CSI-ReportConfig) which indicates a frequency granularity of the CSI report, where a subband may be defined as N_{PRB}^{SB} contiguous physical resource blocks (PRBs) and depends on the total number of PRBs in the bandwidth part. The UE may further receive an indication of the subbands for which the CSI feedback is requested. In some examples, a subband mask is configured for the requested subbands for CSI reporting The UE computes precoders for each requested sub band and finds the PMI that matches the computed precoder on each of the sub bands.

### Compressed CSI Feedback Coefficient Reporting

As discussed above, a user equipment (UE) may be configured for channel state information (CSI) reporting, for example, by receiving a CSI configuration message from the base station. In certain systems (e.g., Release 15 5G NR), the UE may be configured to report at least a Type II precoder across configured frequency domain (FD) units. For example, the precoder matrix Wᵣ for layer r includes the W₁ matrix, reporting a subset of selected beams using spatial compression and the W_{2,r} matrix, reporting (for cross-polarization) the linear combination coefficients for the selected beams (2L) across the configured FD units:

$${W}_{r} = {\sum }_{i = 0}^{2 L - 1} {b}_{i} \cdot {c}_{i} where {c}_{i} = [ {\underbrace{\begin{matrix}{c}_{i , 0} … \frac{{c}_{i , N}}{3} & {3}^{- 1}\end{matrix}}}_{N} ]$$

where bᵢ is the selected beam, cᵢ is the set of linear combination coefficients (i.e., entries of W_{2,r} matrix), L is the number of selected spatial beams, and N₃ corresponds to the number of frequency units (e.g., subbands, resource blocks (RBs), etc.). In certain configurations, L is RRC configured. The precoder is based on a linear combination of DFT beams. The Type II codebook may improve MU-MIMO performance. In some configurations considering there are two polarizations, the W_{2,r} matrix has size 2L×N₃.

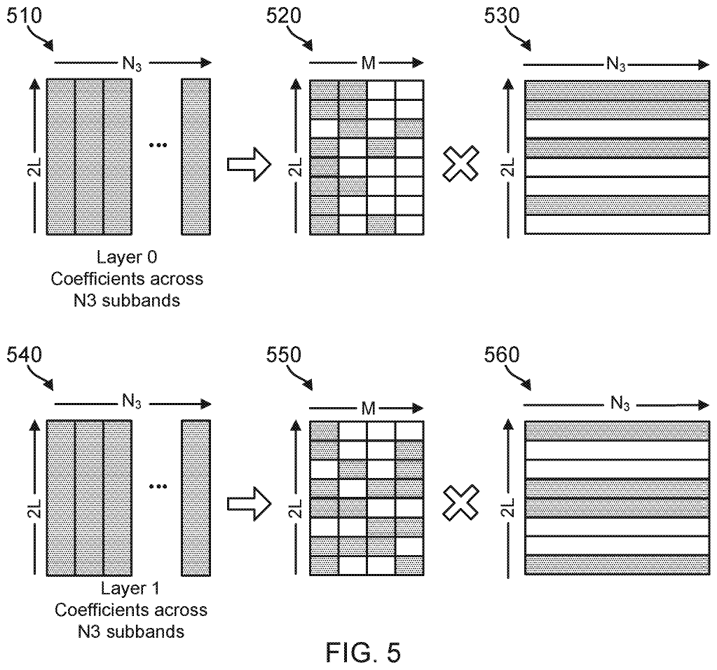

In certain systems (e.g., Rel-16 5G NR), the UE may be configured to report FD compressed precoder feedback to reduce overhead of the CSI report. As shown in FIG. 5, the precoder matrix (W_{2,i}) for layer i with i=0,1 may use an FD compression W_{f,i}^{H} matrix to compress the precoder matrix into \tilde{W}_{2,1} matrix size to 2L×M (where M is network configured and communicated in the CSI configuration message via RRC or DCI, and M<N₃) given as:

Wᵢ=W₁\tilde{W}_{2,i}W_{f,i}^{H}

Where the precoder matrix Wᵢ (not shown) has P=2N₁N₂ rows (spatial domain, number of ports) and N₃ columns (frequency-domain compression unit containing RBs or reporting sub-bands), and where M bases are selected for each of layer 0 and layer 1 independently. The \tilde{W}_{2,0} matrix 520 consists of the linear combination coefficients (amplitude and co-phasing), where each element represents the coefficient of a tap for a beam. The \tilde{W}_{2,0} matrix 520 as shown is defined by size 2L×M, where one row corresponds to one spatial beam in Wᵢ (not shown) of size P×2L (where L is network configured via RRC), and one entry therein represents the coefficient of one tap for this spatial beam. The UE may be configured to report (e.g., CSI report) a subset K₀<2LM of the linear combination coefficients of the \tilde{W}_{2,0} matrix 520. For example, the UE may report K_{NZ,i}<K₀ coefficients (where K_{NZ},i corresponds to a maximum number of nonzero coefficients for layer-i with i=0 or 1, and K₀ is network configured via RRC) illustrated as shaded squares (unreported coefficients are set to zero). In some configurations, an entry in the \tilde{W}_{2,0} matrix 520 corresponds to a row of W_{f,0}^{H} matrix 530. In the example shown, both the \tilde{W}_{2,0} matrix 520 at layer 0 and the \tilde{W}_{2,0} matrix 550 at layer 1 are 2L×M.

The W_{f,o}^{H} matrix 530 is composed of the basis vectors (each row is a basis vector) used to perform compression in frequency domain. In the example shown, both the W_{f,o}^{H} matrix 530 at layer 0 and the W_{f,1}^{H} matrix 560 at layer 1 include M=4 FD basis (illustrated as shaded rows) from N₃ candidate DFT basis. In some configurations, the UE may report a subset of selected basis of the W_{f,1}^{H} matrix via CSI report. The M bases specifically selected at layer 0 and layer 1. That is, the M bases selected at layer 0 can be same/partially-overlapped/non-overlapped with the M bases selected at layer 1.

### Frequency Domain Compression for High Rank Indication

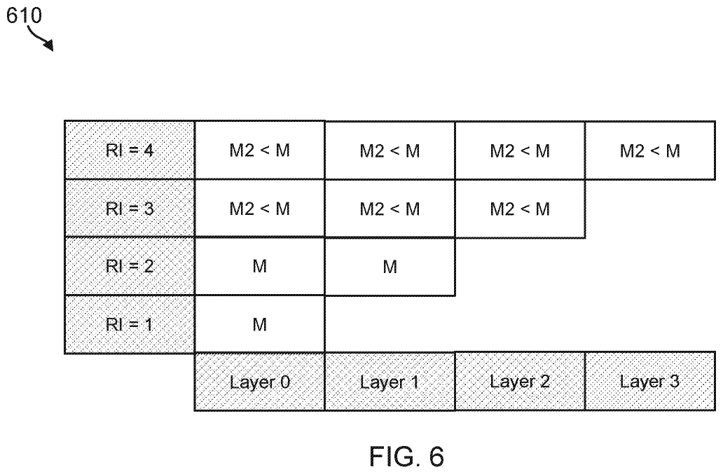

FIG. 6 illustrates three alternative examples for determining the FD basis for a particular RI. Each example is illustrated as a table having a left column indicative of an RI (e.g., RI={1, 2, 3, 4 }), and a bottom row indicative of a transmission layer (e.g., layer 0, layer 1, layer 2, layer 3). That is, the number of layers indicate a transmission rank, where RI=1 is limited to a single spatial layer, RI=2 corresponds to two spatial layers, RI=3 corresponds to three spatial layers, and RI=4 corresponds to four spatial layers. Accordingly, type II CSI may relate to UEs having up to four spatial layers.

In some configurations using FD compression, regardless of the rank, up to KO non-zero coefficients (NZCs) are reported each layer, and the total number of NZCs across all layers is constrained at 2K₀. That is, for rank-1 and rank-2, only the per-layer constraint needs to be considered, as the total NZCs constraint across layers become redundant (since the total NZCs of the two layers, constrained at K₀ each, cannot exceed 2K₀). For rank-3 and rank-4, on the other hand, both the per-layer constraint and the total constraint would be considered.

Similarly, the FD basis (Mᵢ) for RI={3, 4} is comparable to RI=2. In one example, each layer (layer 0 and layer 1) of RI=2 uses M number of FD basis, making the FD basis across all four layers of RI=4 comparable to 2M. That is, Mᵢ for a given RI can be described as:

$${\sum }_{i = 0}^{RI - 1} {M}_{i} \approx 2 M$$

In the example shown in FIG. 5, the W_{f,o}^{H} matrix 530 includes FD basis M=4 (M₀=4), and the W_{f,1}^{H} matrix 560 includes FD basis M=4 (M₁=4), making a total of 8 FD bases for RI=2. Thus, for RI={3, 4} the total number of FD bases across all four layers should be comparable to M₀+M₁ or 2M (e.g., between 6 and 10 FD basis for RI={3, 4}).

As shown in FIG. 6, table 610 illustrates an example for making the total number of FD basis for RI={3, 4} comparable to RI=2. In this example, the FD basis for each of layers 0-3 is M2 for RI={3, 4}. In some cases, M2 may be set in a standard specification equal to M/2 or ⅔*M. The M value may be determined, for example, by the following equation:

$$M = c e i l ( p * N 3 ) ,$$

while M2 may be determined by the following equation:

$$M 2 = ceil ( v 0 * N 3 ) ,$$

where p and v0 are jointly configured, for example from:

$$( p , v 0 ) = ( 1 / 2 , 1 / 4 ) , ( 1 / 4 , 1 / 4 ) and ( 1 / 4 , 1 / 8 )$$

In aspects of the techniques described herein, a UE may be configured for CSI reporting, for example, by receiving a CSI configuration message from a base station. In certain systems, the UE may be configured to report at least a Type II precoder across configured frequency domain (FD) units. For example, a precoder for a certain layer l on N3 subbands may be expressed as a size-P×N₃ matrix Wᵢ:

$${W}_{i} = [ \begin{matrix}{\sum }_{i = 0}^{L - 1} {\sum }_{m = 0}^{M - 1} {v}_{{m}_{1}^{( i )} {m}_{2}^{( i )}} \\ {\sum }_{i = 0}^{L - 1} {\sum }_{m = 0}^{{M}_{i} - 1} {v}_{{m}_{1}^{( i )} {m}_{2}^{( i )}}\end{matrix} , \begin{matrix}{p}_{i , m}^{( 1 )} {p}_{i , m}^{( 2 )} φ i , m \cdot {f}_{{m}_{3}^{( m )}}^{H} \\ {p}_{i + L , m}^{( 1 )} {p}_{i + L , m}^{( 2 )} φ i + L , m \cdot {f}_{{m}_{3}^{( m )}}^{H}\end{matrix} ]$$

In this equation, L is the number of spatial domain (SD) basis (or bases) (e.g., spatial beams) configured by RRC signaling of the CSI report configuration, vₘ_{₁}_{⁽ⁱ⁾}ₘ_{₂}_{⁽ⁱ⁾} with i=0,1, . . . , L−1 is P/2×1 SD basis and it is applied to both polarizations. The 2 SD bases are DFT based and the SD basis with index m₁⁽ⁱ⁾ and m₂⁽ⁱ⁾ may be written as:

$$\begin{matrix}{v}_{{m}_{1}^{( i )} {m}_{2}^{( i )}} = {[ {u}_{{m}_{2}^{( i )}} {e}^{\frac{j 2 π {m}_{1}^{( i )}}{{0}_{1} {N}_{1}}} {u}_{{m}_{2}^{( 1 )}} … {e}^{\frac{j 2 π {m}_{1}^{( i )} ( {N}_{1} - 1 )}{{0}_{1} {N}_{1}}} {u}_{{m}_{2}^{( 1 )}} ]}^{T} \\ {u}_{{m}_{2}^{( 1 )}} = [ \frac{j 2 π {m}_{2}^{( i )}}{1 {e}^{{0}_{2} {N}_{2}}} … \frac{j 2 π {m}_{2}^{( i )} ( {N}_{2} - 1 )}{{e}^{{0}_{2} {N}_{2}}} ]\end{matrix}$$

In this equation, N₁ and N₂ represents the first and the second dimension of the configured codebook, respectively. In some cases, these parameters may refer to the number of antenna elements on the vertical and horizontal dimension at the base station, respectively. The oversampling factors are denoted by 0₁ and 0₂.

Moreover, fₘ_{₃}_{^{(m)}} m=0,1, . . . Mₗ is a N₃×1 FD basis (i.e., fₘ_{₃}_{^{(m)}}^{H} is a 1×N₃ vector) which may also be known as the transferred domain basis. M₁ is the number of FD bases selected for layer l and it is derived based on RRC configuration. In some cases, for each layer of rank-1 and rank-2, there are M bases and value of

$$M = [ px \frac{{N}_{3}}{R} ]$$

is determined by a ratio p configured by RRC and R is the number of precoding matrix indicator (PMI) subbands within one CQI subband. The FD bases may be DFT bases, and the FD basis with index m₃^{(m)}∈{0,1, . . . N₃−1} is expressed as:

$${f}_{{m}_{3}^{( m )}} = [ \frac{j 2 π {m}_{3}^{( m )}}{1 {e}^{{N}_{3}}} … \frac{j 2 π {m}_{3}^{( m )} ( {N}_{3} - 1 )}{{e}^{{N}_{3}}} ]$$

As noted above, linear combination coefficient may include three parts: [symbol] _{i,l,m}⁽¹⁾, [symbol] _{i,l,m}⁽²⁾, φi, l, m. The parameter [symbol] _{i,l,m}⁽¹⁾ represents an amplitude reference for the first polarization, while [symbol] _{i+L,l,m}⁽¹⁾ represents the amplitude reference for the second polarization. These values are common to all the coefficients associated with the corresponding polarization (e.g., [symbol] _{i,l,m}⁽¹⁾= [symbol] _{i′+L,l,m′}⁽¹⁾ and [symbol] _{i+L,l,m}⁽¹⁾ = [symbol] _{i′+L,l,m′}⁽¹⁾, ∀i′∈{i′≠i|i′=0,1, . . . L−1}, ∀m′∈{m′≠m|m′=0,1, . . . M}). The parameter p.(2) i,l,m represents a (differential) amplitude the coefficient associated with SD basis with index m₁⁽ⁱ⁾ m₂⁽ⁱ⁾, and associated with the FD basis with index m₃⁽ⁱ⁾ in the first polarization, while [symbol] _{i+L,m}⁽²⁾ represents a (differential) amplitude the coefficient associated with SD basis with index m₁⁽ⁱ⁾ and m₂⁽ⁱ⁾, and associated with the FD basis with index m₃^{(m)}) in the second polarization. Similarly, the parameter φ_{i,m} represents a (differential) amplitude the coefficient associated with SD basis with index m₁⁽ⁱ⁾ and m₂⁽ⁱ⁾, and associated with the FD basis with index m₃^{(m)} in the first polarization, while φ_{i+L,m} represents a (differential) amplitude the coefficient associated with SD basis with index m₁⁽ⁱ⁾ and m₂⁽ⁱ⁾ and associated with the FD basis with index m₃^{(m)}) in the second polarization.

For RI={1,2}, for each layer, the number of FD bases M=M_{1,2,} wherein the value of

$${M}_{1 , 2} = [ p \times \frac{{N}_{3}}{R} ]$$

is determined by a ratio p configured by RRC and R is the number of precoding matrix indicator (PMI) subbands within one CQI subband. For RI={3,4}, the number of FD bases M=M_{3,4}, wherein the value of

$${M}_{3 , 4} = [ {v}_{0} \times \frac{{N}_{3}}{R} ]$$

is determined by a ratio v₀ configured by RRC. Possible combinations of p and v₀

$$( p , {v}_{0} ) = ( \frac{1}{2} , \frac{1}{4} ) , ( \frac{1}{4} , \frac{1}{4} ) , ( \frac{1}{4} , \frac{1}{8} ) .$$

Moreover, for each layer of RI={1,2,3,4 }, the UE is configured to report a subset of total 2 LM_{1,2} or total 2 LM_{3,4} coefficients, the unreported coefficients are set to zero. The max number of coefficients to be reported per layer is K₀ and the max total number of coefficients to be reported across all layers is 2K₀, where

$${K}_{0} = ⌈ β \times 2 L {M}_{1 , 2} ⌉ and β = \{ \frac{1}{4} , \frac{1}{2} , \frac{3}{4} \}$$

is RRC. It may be noted that, regardless of rank, K₀ is calculated using the M_{1,2}.

With codebook operation with FD compression, for a layer l, its precoder across N₃ FD units (a.k.a. PMI subbands) is given by a size-Nₜ×N₃matrix W₁ as follows:

$${W}_{i} = {W}_{1} \times {\tilde{W}}_{2 , 1} \times {W}_{f , l}^{H} ,$$

Where W₁, \tilde{W}₂ and W_{f} are as follows:

| Notation | size | description | Comment |
|---|---|---|---|
| W₁ | Nₜ × 2L | SD basis; same SD bases are | Layer-common |
| | | applied to both polarizations | |
| \tilde{W}_{2, l} | 2L × M | Coefficient matrix: | Layer-specific; |
| | | Consist of max K₀ NZC per-layer; | |
| | | Consist of max 2K₀ NZC across | |
| | | all layers | |
| W_{f, l} | M × N₃ | FD basis; same M FD bases are | Layer-specific; |
| | | applied to both polarizations | |

Note:
L value is rank-common and layer-common
M value is rank-group specific and layer-common. M = M_{1, 2} for RI = {1, 2} and M = M_{3, 4} ≤ M_{1, 2} for RI = {3, 4}

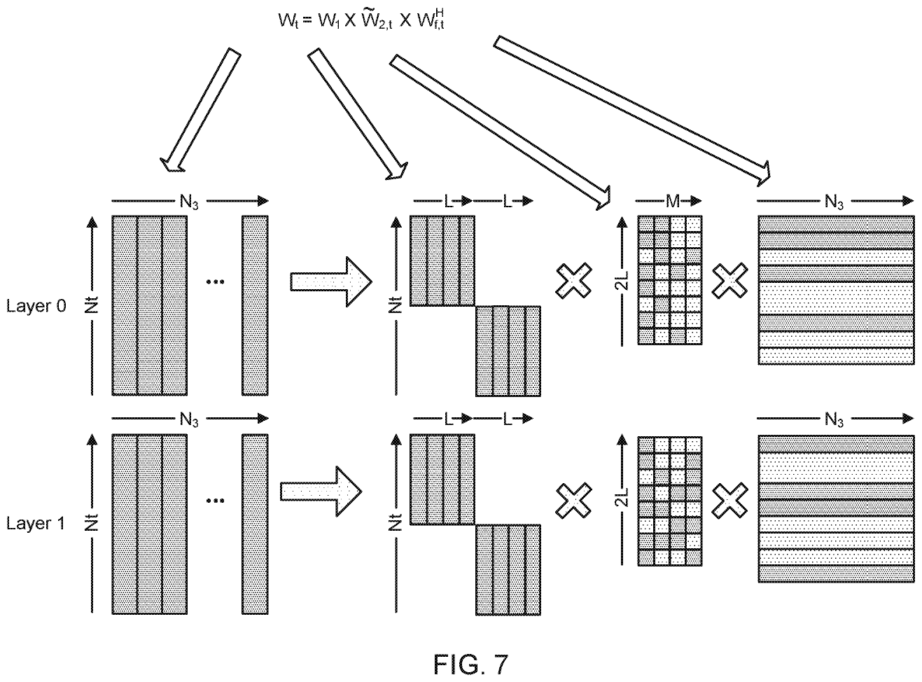

These three matrices, illustrated graphically in FIG. 7 (it should be noted that while FIG. 7 only show two layers, it can be actually 3 or 4 layers with same structure, with the only difference being in the number of FD bases and number of non-zero coefficients or NZCs), can be written as:

$${W}_{1} [ \begin{matrix}{v}_{{{m}_{1}}^{( 0 )} , {{m}_{2}}^{( 0 ) ,}} {v}_{{{m}_{1}}^{( 1 )} , {{m}_{2}}^{( 1 ) , …}} {v}_{{{m}_{1}}^{( L - 1 )} , {{m}_{2}}^{( L - 1 )}} & \\ & {v}_{{{m}_{1}}^{( 0 )} , {{m}_{2}}^{( 0 ) ,}} {v}_{{{m}_{1}}^{( 1 )} , {{m}_{2}}^{( 1 ) , …}} {v}_{{{m}_{1}}^{( L - 1 )} , {{m}_{2}}^{( L - 1 )}} ]\end{matrix}$$

$${W}_{f , l}^{h} = [ \begin{matrix}{f}_{{m}_{3 , l}^{( 0 )}}^{H} \\ {f}_{{m}_{3 , l}^{( 1 )}}^{H} \\ ⋮ \\ {f}_{{m}_{3 , l}^{( M - 1 )}}^{H}\end{matrix} ]$$

$${\tilde{W}}_{2 , 1} = [ \begin{matrix}{p}_{0 , l , 0}^{( 1 )} {p}_{0 , l , {0}^{{e}^{j {∅}_{0 , l , 0}}}}^{( 2 )} & {p}_{0 , l , 1}^{( 1 )} {p}_{0 , l , {1}^{{e}^{j {∅}_{0 , l , 1}}}}^{( 2 )} & … & {p}_{0 , l , M - 1}^{( 1 )} {p}_{0 , l , M - {1}^{{e}^{j {∅}_{0 , l , M - 1}}}}^{( 2 )} \\ {p}_{1 , l , 0}^{( 1 )} {p}_{0 , l , {0}^{{e}^{j {∅}_{1 , l , 0}}}}^{( 2 )} & {p}_{1 , l , 1}^{( 1 )} {p}_{1 , l , {1}^{{e}^{j {∅}_{0 , l , 1}}}}^{( 2 )} & … & {p}_{1 , l , M - 1}^{( 1 )} {p}_{1 , l , M - {1}^{{e}^{j {∅}_{1 , l , M - 1}}}}^{( 2 )} \\ ⋮ & ⋮ & ⋱ & ⋮ \\ {p}_{L - 1 , l , 0}^{( 1 )} {p}_{L - 1 , l , {0}^{{e}^{j {∅}_{L - 1 , l , 0}}}}^{( 2 )} & {p}_{L - 1 , l , 1}^{( 1 )} {p}_{L - 1 , l , {1}^{{e}^{j {∅}_{L - 1 , l , 1}}}}^{( 2 )} & … & {p}_{L - 1 , l , M - 1}^{( 1 )} {p}_{L - 1 , l , M - {1}^{{e}^{j {∅}_{L - 1 , l , M - 1}}}}^{( 2 )} \\ {p}_{L , l , 0}^{( 1 )} {p}_{L , l , {0}^{{e}^{j {∅}_{L , l , 0}}}}^{( 2 )} & {p}_{L , l , 1}^{( 1 )} {p}_{L , l , {1}^{{e}^{j {∅}_{L , l , 1}}}}^{( 2 )} & … & {p}_{L , l , M - 1}^{( 1 )} {p}_{L , l , M - {1}^{{e}^{j {∅}_{L + 1 , l , M - 1}}}}^{( 2 )} \\ {p}_{L + 1 , l , 0}^{( 1 )} {p}_{L + 1 , l , {0}^{{e}^{j {∅}_{L + 1 , l , 0}}}}^{( 2 )} & {p}_{L + 1 , l , 0}^{( 1 )} {p}_{L + 1 , l , {1}^{{e}^{j {∅}_{L + 1 , l , 1}}}}^{( 2 )} & … & {p}_{L + 1 , l , M - 1}^{( 1 )} {p}_{L + 1 , l , M - {1}^{{e}^{j {∅}_{L + 1 , l , M - 1}}}}^{( 2 )} \\ ⋮ & ⋮ & ⋱ & ⋮ \\ {p}_{2 L - 1 , l , 0}^{( 1 )} {p}_{2 L - 1 , l , {0}^{{e}^{j {∅}_{L - 1 , l , 0}}}}^{( 2 )} & {p}_{2 L - 1 , l , 1}^{( 1 )} {p}_{2 L - 1 , l , {1}^{{e}^{j {∅}_{L - 1 , l , 1}}}}^{( 2 )} & … & {p}_{2 L - 1 , l , M - 1}^{( 1 )} {p}_{2 L - 1 , l , M - {11}^{{e}^{j {∅}_{L - 1 , l , M - 1}}}}^{( 2 )}\end{matrix} ]$$

Where the SD bases are DFT based and the SD basis with index m₁⁽ⁱ⁾ and m₂⁽ⁱ⁾ is written as

$$\begin{matrix}{v}_{{m}_{1}^{( i )} {m}_{2}^{( i )}} = {[ {u}_{{m}_{2}^{( i )}} \frac{j 2 π {m}_{1}^{( i )}}{{e}^{{0}_{1} {N}_{1}}} {u}_{{m}_{2}^{( 1 )}} … \frac{j 2 π {m}_{1}^{( i )} ( {N}_{1} - 1 )}{{e}^{{0}_{1} {N}_{1}}} {u}_{{m}_{2}^{( 1 )}} ]}^{T} , \\ {u}_{{m}_{2}^{( 1 )}} = [ \begin{matrix}1 & e \frac{j 2 π {m}_{2}^{( i )}}{{0}_{2} {N}_{2}} & … & \frac{j 2 π {m}_{2}^{( i )} ( {N}_{2} - 1 )}{{e}^{{0}_{2} {N}_{2}}}\end{matrix} ]\end{matrix}$$

The FD bases may be DFT bases, and the FD basis with index m₃^{(m) ∈}∈{0,1. . . N₃−1 } is expressed as:

$${f}_{{m}_{3 , 1}^{( m )}}^{H} = [ \begin{matrix}1 & e \frac{j 2 π {m}_{2}^{( i )}}{{N}_{3}} & … & e \frac{j 2 π {m}_{2}^{( i )} ( {N}_{2} - 1 )}{{0}_{2} {N}_{2}}\end{matrix} ]$$

The coefficients p_{i,m,l′}⁽ⁱ⁾, P_{i,m,l}⁽²⁾, and φ_{i,m,l} may be described as follows:

| Notation | description | Alphabet |
|---|---|---|
| P_{i,m,l}⁽¹⁾ | Reference amplitude for the 1st polarization. p_{i,m,l}⁽¹⁾ = p_{i′m′l′}⁽¹⁾ ∀i′ ≠ i, m′ ≠ m | $\{ \begin{matrix}1 , & {( \frac{1}{2} )}^{\frac{1}{4}} , & {( \frac{1}{2} )}^{\frac{1}{2}} , & {( \frac{1}{2} )}^{\frac{3}{4}} , & {( \frac{1}{2} )}^{1} , & {( \frac{1}{2} )}^{\frac{5}{4}} , \\ {( \frac{1}{2} )}^{\frac{3}{2}} , & {( \frac{1}{2} )}^{\frac{7}{4}} , & {( \frac{1}{2} )}^{2} , & {( \frac{1}{2} )}^{\frac{9}{4}} , & {( \frac{1}{2} )}^{\frac{5}{2}} , & {( \frac{1}{2} )}^{\frac{11}{4}} , \\ {( \frac{1}{2} )}^{3} , & {( \frac{1}{2} )}^{\frac{13}{4}} , & {( \frac{1}{2} )}^{\frac{7}{2}} & & & \end{matrix} \}$ |
| P_{i+L,m,l}⁽¹⁾ | Reference amplitude for the 2nd polarization. P_{i+L,m,l}⁽¹⁾ = p_{i′+L,m′,l}⁽¹⁾, ∀i′ ≠ i, m′ ≠ m | $\{ \begin{matrix}1 , & {( \frac{1}{2} )}^{\frac{1}{4}} , & {( \frac{1}{2} )}^{\frac{1}{2}} , & {( \frac{1}{2} )}^{\frac{3}{4}} , & {( \frac{1}{2} )}^{1} , & {( \frac{1}{2} )}^{\frac{5}{4}} , \\ {( \frac{1}{2} )}^{\frac{3}{2}} , & {( \frac{1}{2} )}^{\frac{7}{4}} , & {( \frac{1}{2} )}^{2} , & {( \frac{1}{2} )}^{\frac{9}{4}} , & {( \frac{1}{2} )}^{\frac{5}{2}} , & {( \frac{1}{2} )}^{\frac{11}{4}} , \\ {( \frac{1}{2} )}^{3} , & {( \frac{1}{2} )}^{\frac{13}{4}} , & {( \frac{1}{2} )}^{\frac{7}{2}} & & & \end{matrix} \}$ |
| P_{i,m,l}⁽²⁾ and P_{i+L,m,l}⁽²⁾ | Differential amplitude for each individual coefficient | $\{ \begin{matrix}1 , & \sqrt{\frac{1}{2} ,} & \sqrt{\frac{1}{4} ,} & \sqrt{\frac{1}{8} ,} & \sqrt{\frac{1}{16} ,} \\ \sqrt{1 / 32} & \sqrt{1 / 64} & \sqrt{1 / 128} & & \end{matrix} \}$ |
| φ_{i,m,l} | Phase of each individual | N-PSK, N = 8 OR 16 |
| and | coefficient | |
| φ_{i+L,m,l} | | |

Given these definitions, more precisely, the linear combination representation may be expressed as:

$${W}_{i} = ( \begin{matrix}{\sum }_{i = 0}^{L - 1} {\sum }_{m = 0}^{M - 1} {v}_{{m}_{1}^{( i )} , {m}_{2}^{( i )} ,} {p}_{i , m , l}^{( 1 )} {p}_{i , m , l}^{( 2 )} φi , m , l \cdot {f}_{{m}_{3 , l}^{( m )}}^{H} \\ {\sum }_{i = 0}^{L - 1} {\sum }_{m = 0}^{M - 1} {v}_{{m}_{1}^{( i )} {m}_{2}^{( i )} {p}_{i + L , m , l}^{( 1 )} {p}_{i + L , m , l}^{( 2 )}} φi + L , m , l \cdot {f}_{{m}_{3 , l}^{( m )}}^{H}\end{matrix} )$$

### Example UL Subband Precoding via Linear Combination of FD Bases

Some deployments (e.g., NR Release 15 and 16 systems) support codebook-based transmission and non-codebook-based transmission schemes for uplink transmissions with wideband precoders. Codebook-based UL transmission is based on BS feedback and can be used in cases where reciprocity may not hold.

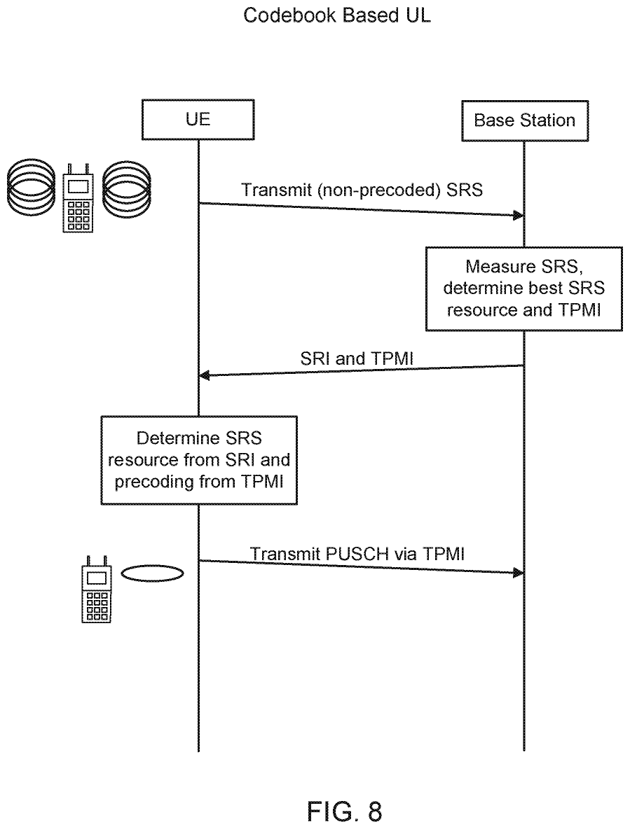

FIG. 8 is a call flow diagram illustrating an example of conventional codebook based UL transmission using a wideband precoder. As illustrated, a UE transmits (non-precoded) SRS with up to 2 SRS resources (with each resource having 1, 2 or 4 ports). The gNB measures the SRS and, based on the measurement, selects one SRS resource and a wideband precoder to be applied to the SRS ports within the selected resource.

As illustrated, the gNB configures the UE with the selected SRS resource via an SRS resource indictor (SRI) and with the wideband precoder via a transmit precoder matrix indicator (TPMI). For a dynamic grant, the SRI and TPMI may be configured via DCI format 0_1. For a configured grant (e.g., for semi-persistent uplink), SRI and TPMI may be configured via RRC or DCI.

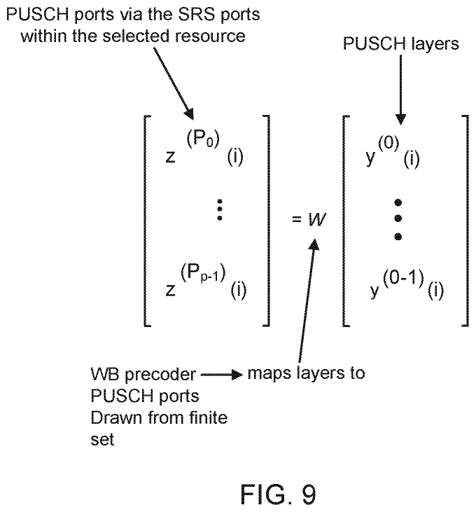

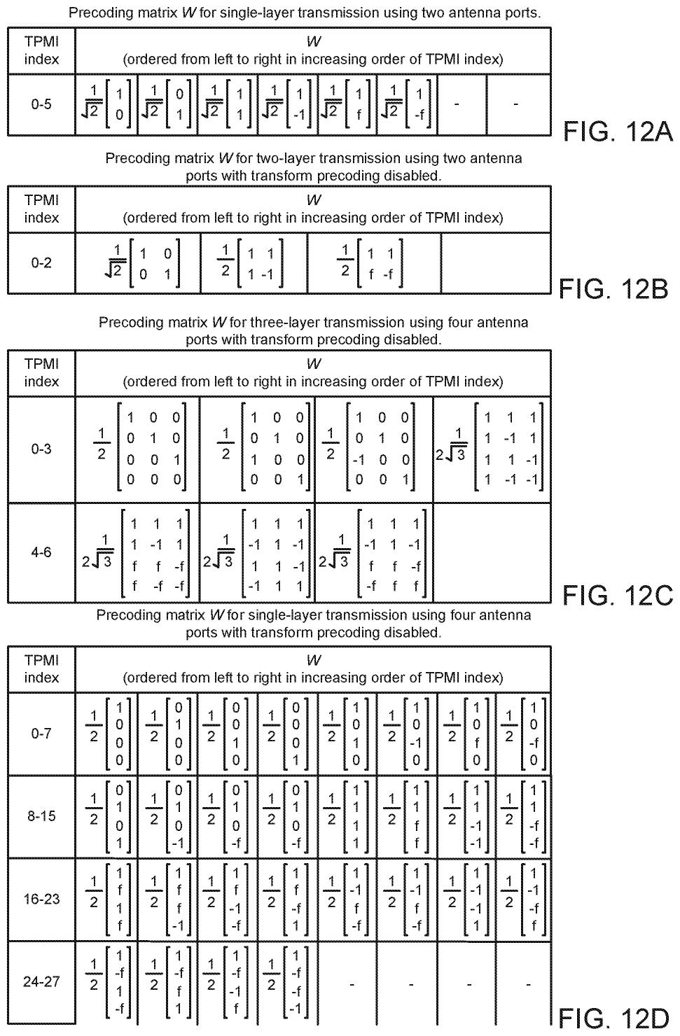

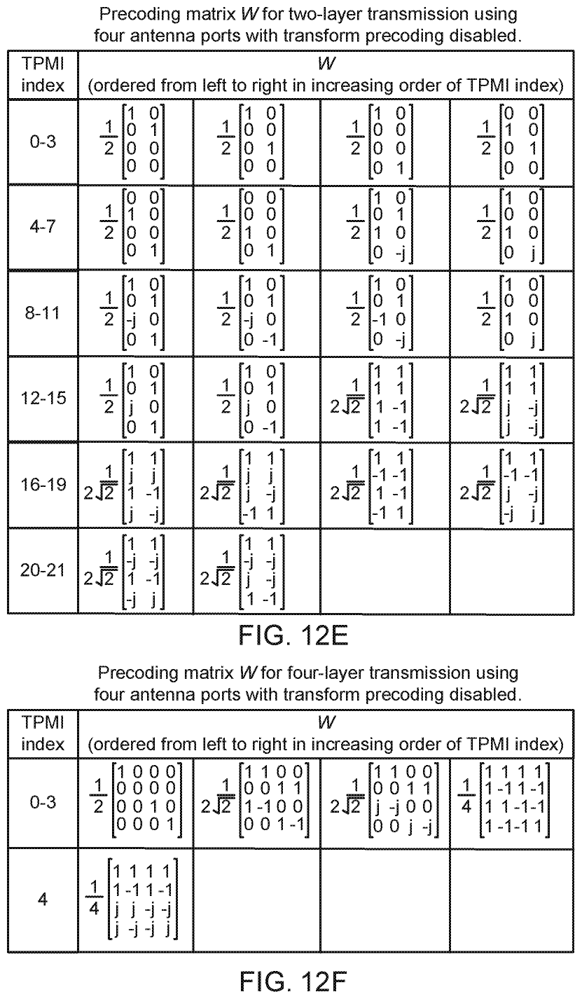

The UE determines the selected SRS resource from the SRI and precoding from TPMI and transmits PUSCH accordingly. FIG. 9 illustrates how the wideband precoder (indicated via TPMI) may map transmission layers to PUSCH ports. FIGS. 12A-12F illustrate example precoder matrix sets that may be selected via a TPMI index, for various layer and antenna port combinations.

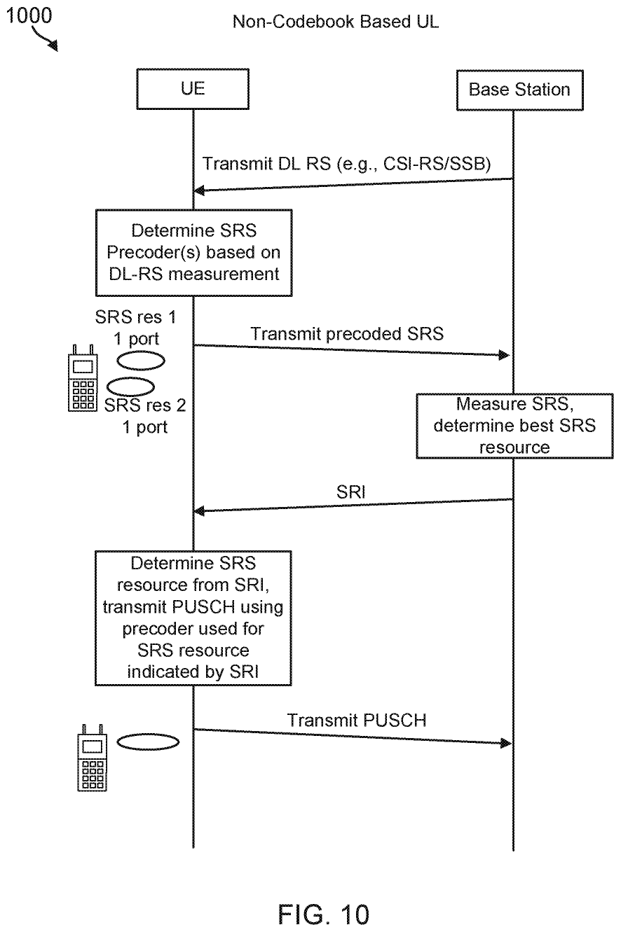

FIG. 10 is a call flow diagram illustrating an example of non-codebook-based UL transmission. As illustrated, a UE transmits (precoded) SRS. While the example shows 2 SRS resources, the UE may transmit with up to 4 SRS resources (with each resource having 1 port). The gNB measures the SRS and, based on the measurement, selects one or more SRS resource. In this case, since the UE sent the SRS precoded, by selecting the SRS resource, the gNB is effectively also selecting precoding. For non-codebook-based UL transmission, each SRS resource corresponds to a layer. The precoder of the layer is actually the precoder of the SRS which is emulated by the UE. Selecting N SRS resources means the rank is N. The UEis to transmit PUSCH using the same precoder as the SRS.

As illustrated, the gNB configures the UE with the selected SRS resource via an SRS resource indictor (SRI). For a dynamic grant, the SRI may be configured via DCI format 0_1. For a configured grant, the SRI may be configured via RRC or DCI.

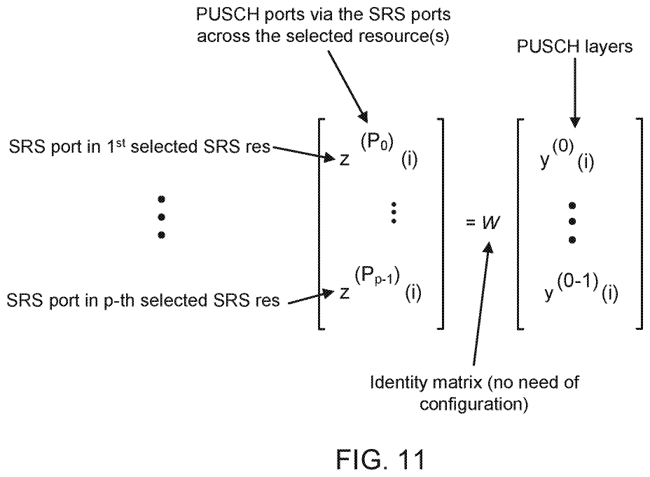

In this case, the UE determines the selected SRS resource from the SRI, selects the same precoder used when sending that selected SRS resource, and transmits PUSCH accordingly. FIG. 11 illustrates how PUSCH ports are effectively selected via the SRS ports across the selected SRS resource (or resources).

As noted above, wideband precoding is typically used for conventional (e.g., Rel-15 and Rel-16) systems. However, subband precoding may, in some cases, provide gain particular in cases where the number of Tx layers is greater than or equal to 4. One challenge with subband precoding for UL transmission is how to define the transmission scheme for sub band precoding and the related signaling (e.g., of the TPMI from the gNB to the UE).

Aspects of the present disclosure propose an UL transmission scheme which achieves subband precoding via a linear combination of frequency domain (FD) bases. As will be described in greater detail below, for each antenna port, one or more FD bases may be applied across all the subbands, and a particular coefficient may be associated with each basis. The gNB measures the UL channel (e.g., based on SRS transmissions) and determine an optimal set of one or more FD bases and the associated coefficients, then configure the FD bases and coefficients to the UE. The resulting subband based precoding may result in a significant performance gain without undue burden in terms of UE implementation.

FIG. 13 illustrates example operations 1300 for wireless communication by a UE for UL subband precoding, in accordance with certain aspects of the present disclosure. Operations 1300 may be performed, for example, by a UE 120 of FIG. 1 or FIG. 3.

Operations 1300 begin, at 1302, by receiving, from a network entity, information indicating at least one of a set of one or more frequency domain (FD) bases and linear combination coefficients. At 1304, the UE determines subband precoding based at least in part on linear combinations of the FD bases based on the linear combination coefficients. At 1306, the UE transmits a physical uplink shared channel (PUSCH) with the subband precoding

FIG. 14 is a flow diagram illustrating example operations 1400 for wireless communication by a network entity (e.g., a base station, such as an eNB or gNB), in accordance with certain aspects of the present disclosure. Operations 1400 may be performed, for example, by BS 110 of FIG. 1 or 3 to configure a UE 120 for UL subband precoding (in accordance with operations 1300 of FIG. 13).

Operations 1400 begin, at 1402, by determining, at least one of a set of one or more frequency domain (FD) bases and linear combination coefficients. At 1404, the network entity determines a subband precoder based at least in part on the at least one of the set of one or more FD bases and linear combination coefficients. At 1406, the network entity transmits, to the UE, information indicating at least one of the set of FDs and linear combination coefficients. At 1408, the network entity receives, from the UE, a physical uplink shared channel (PUSCH) transmitted with subband precoding as linear combinations of the FD bases based on the linear combination coefficients.

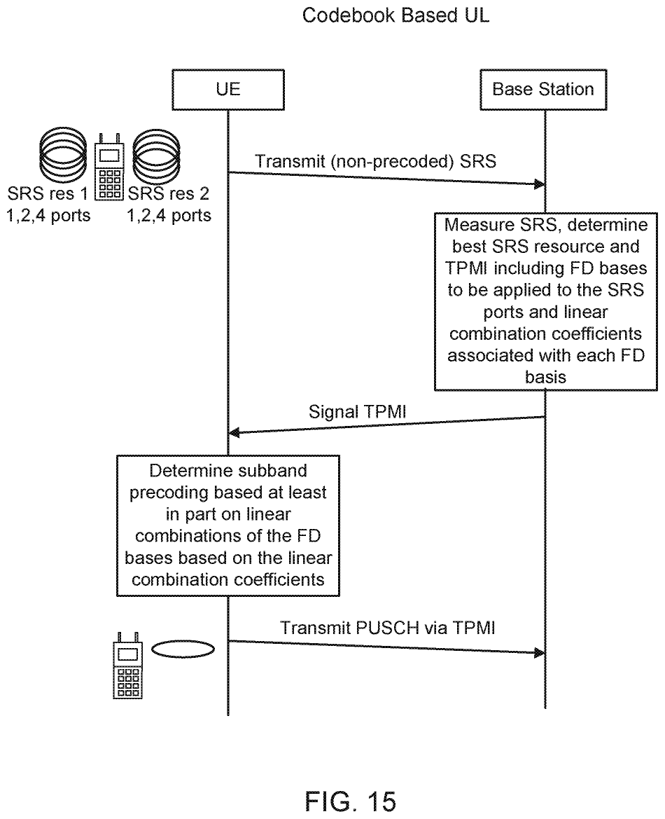

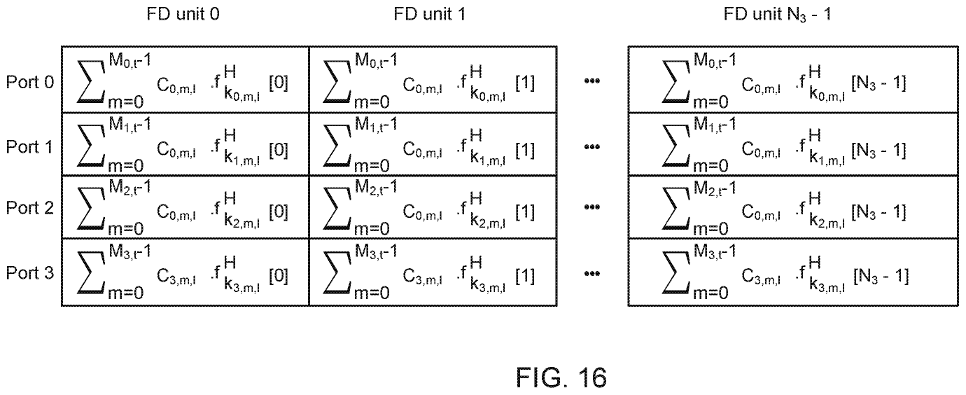

FIG. 15 is a call flow diagram illustrating example UL transmission with subband precoding, which may help in understanding operations 1300 and 1400 of FIGS. 13 and 14. As illustrated, the UE may transmit (non-precoded) SRS. Based on measurement of the SRS, the base station (gNB) selects a set of FD bases and linear combination coefficients associated with each FD basis (collectively included as TPMI).

The gNB then signals this TPMI to the UE. The gNB may transmit the determined FD bases and linear combination coefficients via DCI or RRC or MAC CE to the UE. The UE then transmits PUSCH with subband precoding based on this TPMI (e.g., using linear combinations of FD bases based on the signaled coefficients).

The UL precoder of a layer l∈{0, . . . , v−1} across N3 FD units may be expressed as:

$$\frac{1}{\sqrt{v}} \times [ \begin{matrix}{\sum }_{m = 0}^{{M}_{0 , l} - 1} {c}_{0 , m , l} \cdot {f}_{{k}_{0 , m , l}}^{H} \\ {\sum }_{m = 0}^{{M}_{1 , l} - 1} {c}_{1 , m , l} \cdot {f}_{{k}_{1 , m , l}}^{H} \\ ⋮ \\ {\sum }_{m = 0}^{{M}_{p - 1 , l} - 1} {c}_{p - 1 , m , l} \cdot {f}_{{k}_{p - 1 , m , l}}^{H}\end{matrix} ]$$

where fₖ_{_{i,m,l}}^{H} of size 1×N₃ is the m-th FD applied to SRS port i of layer l and c_{0,m,l} is the linear combination coefficient associated with basis fₖ_{_{i,m,k}}^{H}. FIG. 16 graphically illustrates how linear combinations of FD bases may be applied to 4 SRS ports (Ports 0-3) across N3 FD units. An FD unit may be an UL subband or an UL physical resource group (PRG) or RB or a subcarrier. In some cases, the precoder of a layer l will be normalized to norm

$$\frac{1}{\sqrt{v}}$$

via divided by {square root over (Σᵢ₌₀^{p-1}Σₘ₌₀^{M}^{_{0,l}}⁻¹|c_{0,m,l}|²)}.

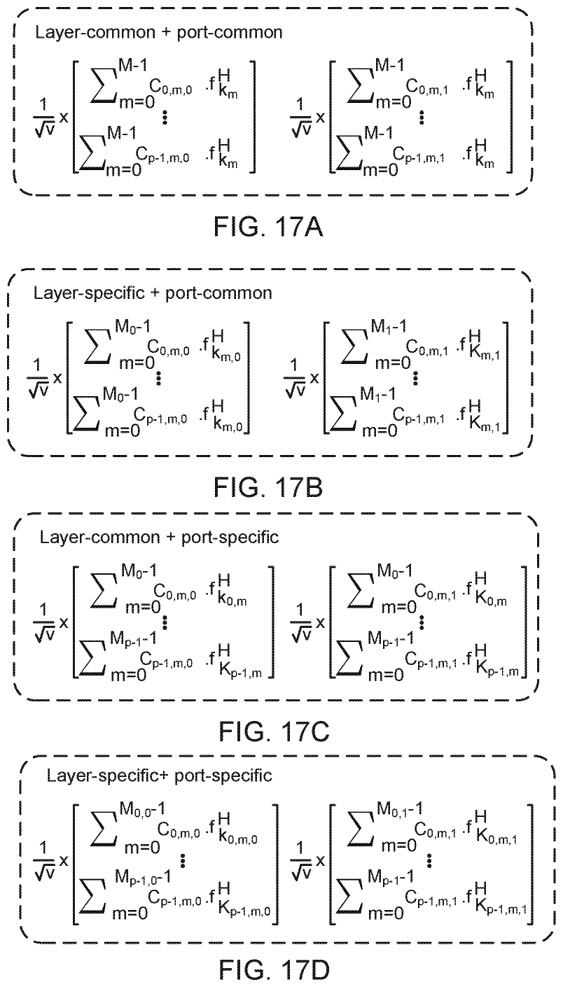

As illustrated in FIGS. 17A-17D, there are various options for configuration of FD bases for UL subband precoding. Each FD basis may be of any suitable type, such as a DFT basis, a DCT basis, Slepian-wolf basis, or fractional DFT basis. Sets of FD bases may be applied in a layer-common or layer-specific manner, as well as antenna port common or antenna port specific manner.

For example, as illustrated in FIG. 17A, in a “layer-common/port-common” approach, the FD bases may include different sets of FD bases, where each set of FD bases is applied to each of the multiple antenna ports for a given transmission layer.

As illustrated in FIG. 17B, in a “layer-specific/port-common” approach, a same set of FD bases may be applied to each of multiple antenna ports and each of multiple spatial layers.

As illustrated in FIG. 17C, in a “layer-common/port-specific” approach, the FD bases may include different sets of FD bases for different antenna ports. For a given antenna port, a same set of FD bases is applied across multiple spatial layers.

As illustrated in FIG. 17D, in a “layer-specific/port-specific” approach, the FD bases may include different sets of FD bases for different antenna ports and different sets of FD bases may be applied for different layers.

There are various approaches for configuring the linear coefficients. In some cases, from total of Σ_{i,l}M_{i,l} FD bases, a gNB may further indicate K_{NZ}≤Σ_{i,l}M_{i,l} nonzero coefficients (coefficients for unindicated ports are assumed to be set to zeros), where M_{i,l} denotes the number of FD bases on antenna port i and layer l.

In some cases, the configuration of coefficients may depend on which of the FD basis approaches (described above) is used. For example, for layer-common FD basis selection, K_{NZ}≤v×ΣᵢMᵢ non-zero coefficients may be indicated where Mₗ denotes the number of FD bases on antenna port i per layer. For port-common FD basis selection, K_{NZ}≤p×ΣₗMₗ non-zero coefficients may be indicated, where Mᵢ denotes the number of FD bases per antenna port on layer l. For layer-common and port-common FD basis selection, K_{NZ}≤p×v×M non-zero coefficients may be indicated, where M denotes the number of FD bases per antenna port per layer.

The format and content of the coefficients may also vary according to various options. For example, according to a first option, per-coefficient quantization may be used. In this case, an amplitude quantization (e.g., |c_{i,m,l}|) of A bits is used. As an alternative, differential quantization for coefficients of a certain port may be and a certain layer (e.g., |c_{i,m,l}|=p_{ref,i,l}·p_{i,m,l}) may be indicated. In such cases, the common part (P_{ref,i,l}) may be A1 bits, while the differential part (p_{i,m,l}) may be A2 bits. A B-bit phase quantization (e.g., angle(c_{i,m,l})) may be indicated.

According to a second options, the coefficients may be indicated via joint-coefficient quantization. In such cases, the non-zero coefficients {c_{i,m,l}, ∀i, m, l} may be jointly selected from a candidate set, such as:

{Combo1{c_{i,m,l}, ∀i, m, l} Combo2{c_{i,m,l}, ∀i, m, l} . . . , ComboN{c_{i,m,l}, ∀i, m, l}}

An example of the sets are illustrated in FIG. 12A˜12F.

In some cases, the gNB may configure a UE with FD bases and coefficients via a two stage DCI signaling (involving first and second DCI transmissions). In such cases, a first DCI may provide sufficient information for a complete precoder. For example, the first DCI may indicate at least one (may be more or all) FD bases and corresponding coefficients. According to one option, one coefficient may be indicated per port per FD basis per layer (e.g, via per-coefficient quantization or joint quantization of the single coefficient across the ports, FD basis and layers). According to another option, a reference amplitude per layer per layer may be indicated.

The second DCI may provide the remaining information for sub band precoding For example, the second DCI may indicate remaining FD bases (if all were not included in the first DCI). The second DCI may also indicate the corresponding coefficients (e.g., remaining coefficients or differential power and phase for each of the coefficients).

Various embodiments address how to determine a size of an FD basis, e.g., whether it is based on SRS or PUSCH. For some embodiments, a boundary condition is that n-th entry of FD basis m is e^{j2π·n*m/N}^{₃}, where n=0,1, . . . , N₃−1. Various embodiments also address how to map the TPMI with an FD basis on an FD unit to the PUSCH transmit signal and/or physical resources.

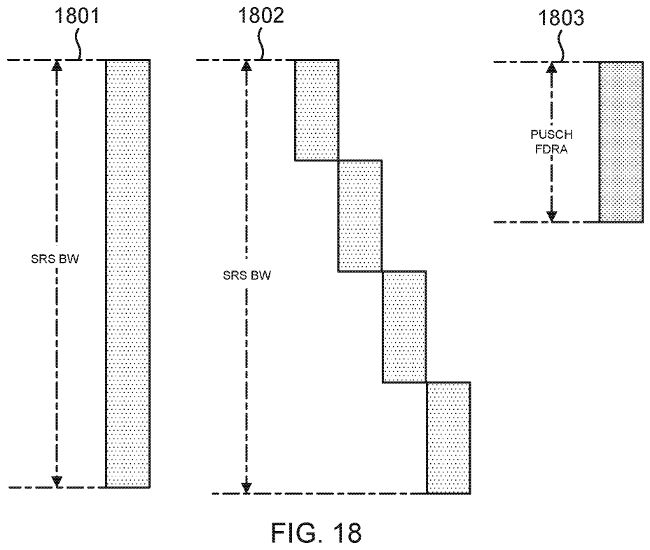

FIG. 18 is an illustration of an example SRS bandwidth and an example PUSCH bandwidth according to one implementation. Specifically, the frequency band for SRS may be a superset of the frequency allocation of a scheduled PUSCH. Illustration 1801 shows an example in which the SRS is transmitted in a single symbol. Illustration 1802 shows an example in which the SRS is hopped; in other words, the system transmits SRS on a certain subband per symbol in order to enhance SRS coverage by increasing the spectral density of each subband. By contrast, the PUSCH frequency domain resource allocation (FDRA) may be smaller than the frequency band of the SRS, although it may be a subset of the SRS frequency band, as shown by illustration 1803.

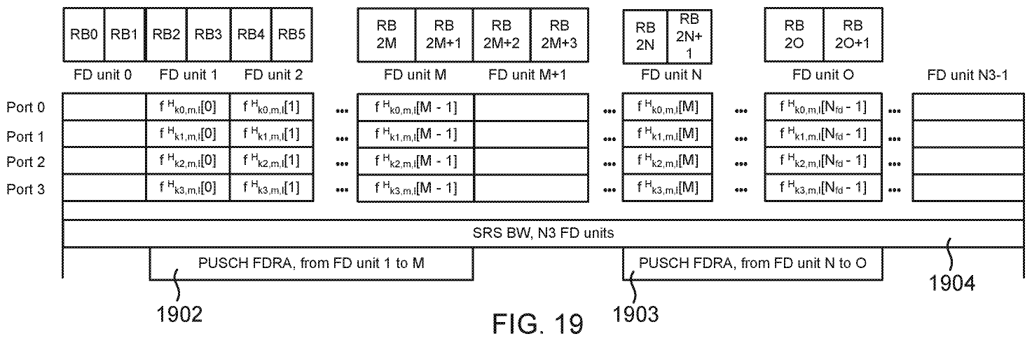

Furthermore, the PUSCH can be assigned Type 0, Type 1, or Type 2. Type 0 can be consecutive or non-consecutive, resource block group (RBG)-based allocation, via N_RBG bitmap. Type 1 is consecutive with a starting RB or RBG index and a length (e.g., #RBs or #RBGs), and PUSCH hopping can be enabled by the RRC parameter frequency HoppingOffsetLists. The different varieties for SRS (e.g., hopped or not hopped) and PUSCH (Types 0-2) may affect various techniques to determine a size of an FD basis and to map the TPMI with an FD basis, as explained in more detail below with respect to FIGS. 19-28.

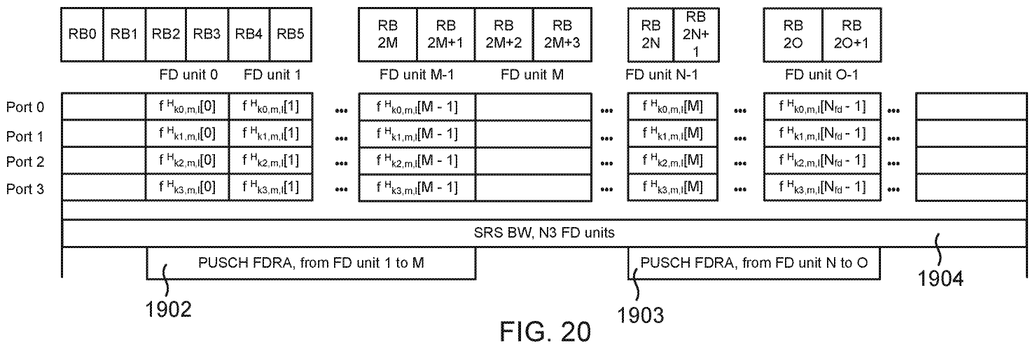

FIGS. 19 and 20 illustrates a technique in which a number of FD units is based on the PUSCH FDRA. In the example of FIGS. 19 and 20, the PUSCH FDRA is non-consecutive in the frequency domain, so it has two segments 1902, 1903. The FDRA is from FD unit 1 to FD unit M and from FD unit N to FD unit O.

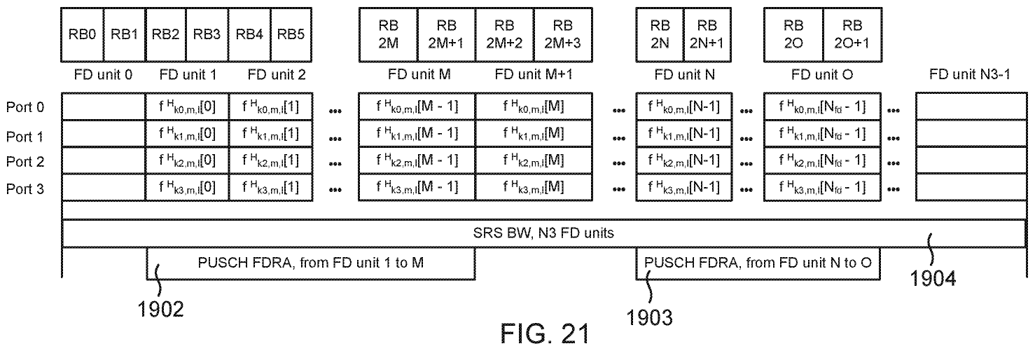

The bandwidth of the SRS 1904 is also shown, and it spans N₃ FD units. In some embodiments, the system may determine a size of the FD units relative to a number of resource blocks (RBs). In the examples of FIGS. 19 and 20 (also, FIGS. 21-27) each FD unit is two RBs, though the scope of implementations is not so limited. Rather, in other embodiments, FD units may be set to more or fewer RBs. Also note that a single FD unit may corresponds to a frequency range equal to that of a resource block group (RBG).

It is also true that the size of the FD basis, i.e., N_{fd}=number of FD units, is determined based on the number of RBs in PUSCH FDRA (N_{RB}^{PUSCH}). The system determines N_{fd} based on N_{RB}^{PUSCH} and the number of RBs per FD unit (M). Every M RBs belong to an FD unit, N_{fd} is the number of FD units which has at least one PUSCH RB in the corresponding FD unit. Also, M is equal to the configured number of physical resource block (PRB) per FD unit, or RBG size; if neither is configured, a default may be used, such as FD unit is equal to RB, i.e., M=1.

A difference in the implementations of FIGS. 19 and 20 is where they begin counting the FD units. Note that the segment 1902 of the PUSCH FDRA does not begin until after RB 1.

Option 1, FIG. 19: the FD unit is counted from the common resource block 0, i.e., FD unit 0={RB 0, . . . , RB M−1 }, FD unit 1={RB M, . . . , RB 2M−1 }, etc.

Option 2, FIG. 20: the FD unit is counted from the lowest (starting) RB index of the PUSCH FDRA, i.e., FD unit 0={RB_start, . . . , RB_start+M−1}, FD unit 1={RB_start+M, . . . , RB_start+2M−1 }, etc. In the example of Figure, RB2 is shown as the starting RB index.

For the TPMI, there is a one-to-one mapping to the PUSCH FDRA. There is a TPMI for each FD unit. Each TPMI includes 1) an entry of the FD basis including the configured set of FD bases for the respective FD unit, and 2) linear combination coefficients associated with each FD basis for the respective FD unit. The system uses these two parts to construct the pre-coder for that particular FD unit. The TPMI for n-th FD unit in PUSCH FDRA is based on the n-th entry of each of the indicated FD basis. In other words, the TPMI on PUSCH FDRA is determined based on the entries of the indicated FD bases in increasing order, wherein the TPMI of the first FD unit is determined based on the first entry of indicated FD bases. Specifically, for the transmitted signal on the i-th PRB of the PUSCH FDRA, the UE determines its FD unit index n(i), and secondly its TPMI is based on the n(i)-th entry of the indicated FD basis, e.g., fₖ_{_{p,m,l}}^{H}[n(i)] for the p-th port. Since it is a non-consecutive PUSCH, the FD units that do not fall within the PUSCH FDRA do not have a calculated FD basis (e.g., FD unit M+1 in FIG. 19 does not have a calculated FD basis).

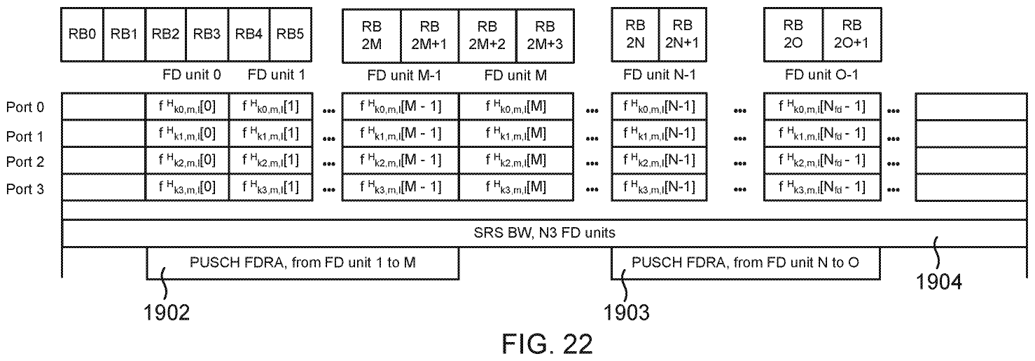

FIGS. 21 and 22 depict another technique in which a number of FD units is based on the PUSCH FDRA. A difference between the embodiments of FIGS. 21-22 and those of FIGS. 19-20 is that in the embodiments of FIGS. 21-22 the system calculates an FD basis even for those FD units that do not fall within the PUSCH FDRA (e.g., FD unit M+1 in FIG. 21). The TPMI is then constructed by disregarding the entries of indicated FD bases that do not correspond to segments 1902, 1903.

The size of FD basis, i.e., N_{fd}=number of FD units, is determined based on the range between the lowest RB index (RBₛₜₐᵣₜ) and highest RB index (RB_{end}) PUSCH FDRA. In the examples of FIGS. 21 and 22, RBₛₜₐᵣₜ is RB2 and RB_{end} is RB2O+1.

The system determines N_{fd} based on RBₛₜₐᵣₜ, RB_{end} and the number of RBs per FD unit M. N_{fd}=FDₛₜₐᵣₜ−FD_{end}+1 where FDₛₜₐᵣₜ and FD_{end} are the starting FD unit and ending FD unit where RBₛₜₐᵣₜ and RB_{end} belong to, respectively.

The embodiments of FIGS. 21-22 begin counting the FD units in a manner similar to that described above with respect to FIGS. 19-20.

Option 1 (FIG. 21): the FD unit is counted from the common resource block 0, i.e., FD unit 0={RB 0, . . . , RB M−1 }, FD unit 1={RB M, . . . , RB 2M−1 }, etc.,

Option 2 (FIG. 22): the FD unit is counted from the lowest (starting) RB index of the PUSCH FDRA, i.e., FD unit 0={RB_start, . . . ,RB_start+M−1}, FD unit 1={RB_start+M, . . . , RB_start+2M−1}, etc.

The TPMI for n-th FD unit in PUSCH FDRA is based on the s(n)-th entry of each of the indicated FD bases, where s(n) is the position of the n-th FD unit in the range formed by the starting and ending RB. The function s(n) depends on the actual PUSCH allocation. The function indicates to just disregard the FD units and their respective entries that do not fall within the PUSCH FDRA. For instance, the system may construct the TPMI by skipping the entries of the indicated FD bases that fall within the gap between PUSCH segments 1902, 1903, skipping the entries of the bases before the beginning of segment 1902, and skipping entries after the end of segment 1903.

For the transmitted signal on the i-th PRB, the UE determines its FD unit index n(i), and secondly its TPMI is based on the s(n(i))-th entry of the indicated FD basis, e.g., fₖ_{_{p,m,l}}^{H}[s(n(i))] for the p-th port.

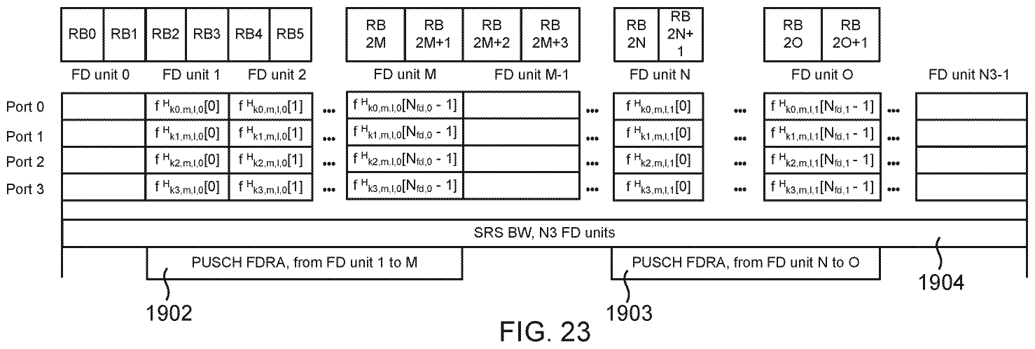

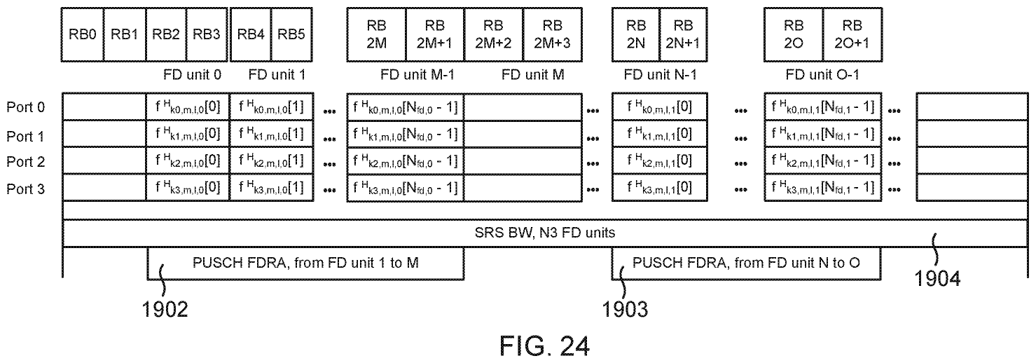

FIGS. 23 and 24 depict another technique in which a number of FD units is based on the PUSCH FDRA. In these examples, no FD units are computed outside of the PUSCH FDRA, similar to the example of FIGS. 19 and 20. The index j is for the PUSCH segments 1902, 1903. The system starts the basis indexing over again for each segment 1902, 1903. The actual FD basis for each segment can be different because the size of the segment can be different. The compression is done per segment, so the compression is done twice in this example because there are two segments 1902, 1903. The scope of implementations is not limited to two segments, as more or fewer segments may be used in other embodiments. Because of the way that the embodiment of FIGS. 23 and 24 performs compression more than once, it may be more computationally intensive and more complex than the embodiments of FIGS. 19-22.

The size of FD basis, i.e., N_{fd}=number of FD units, is determined per PUSCH FDRA segmentation. For the j-th FDRA segmentation, determine its N_{fd,j} based on RB_{start,j}, RB_{end,j} and the number of RBs per FD unit M. N_{fd,j}=FD_{start,j}−FD_{end,j}+1 where FD_{start,j} and FD_{end,j} are the starting FD unit and ending FD unit where RB_{start,j} and RB_{end,j} belong to, respectively. For instance, N_{fd,0} spans from RB2 to RB2M+1, and N_{fd,1} spans from RB2N to RB2O+1.

In FIGS. 23-24, there are two options to begin counting the FD units, and they are the same or similar to those techniques in FIGS. 19-22.

Option 1 (FIG. 23): the FD unit is counted from the common resource block 0, i.e., FD unit 0={RB 0, . . . , RB M−1 }, FD unit 1={RB M, . . . , RB 2M−1}, etc,

Option 2 (FIG. 24): the FD unit is counted from the lowest (starting) RB index per consecutive FDRA segmentation, i.e., FD unit 0={RB_start_j, . . . , RB_start_j +M−1}, FD unit 1={RB_start_j+M, . . . , RB_start_j +2M−1}, etc.

The TPMI for n-th FD unit in the j-th FDRA segmentation is based on the n-th entry of the indicated FD basis for the j-th FDRA segmentation

For the transmitted signal on the i-th PRB, the UE determines its FD unit index n(i) and FDRA segmentation index j(i), and secondly its TPMI is based on the n(i)-th entry of the indicated FD basis for the j(i)-th FDRA segmentation, e.g., fₖ_{_{p,m,l,j(i)}}^{H}[n(i)] for the p-th port. In other words, inside each consecutive PUSCH FDRA segmentation, the TPMI on each FD unit is determined based on the entries of the indicated FD bases in increasing order, wherein the TPMI on the first FD unit of each segmentation is based on the first entry of the indicated FD bases.

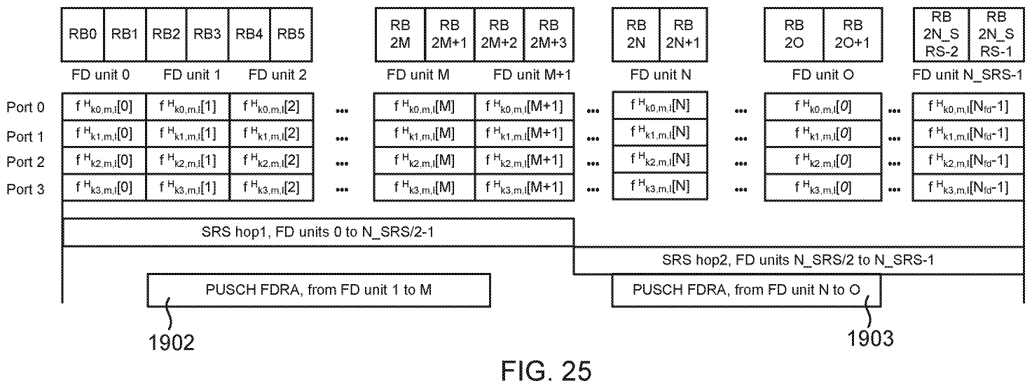

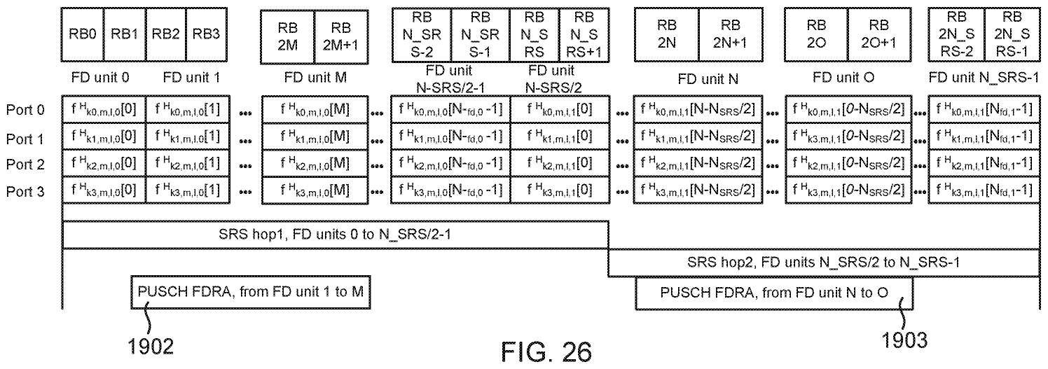

FIGS. 25 and 26 depict a different technique, wherein the number of FD units is based on the SRS bandwidth 1904. In this example, the number of FD units is determined regardless of SRS hopping. The embodiments of FIGS. 25 and 26 calculate FD bases for the entire width of the SRS, though not all entries of the FD bases are included in the TPMI. Rather, only those entries of the indicated FD bases that correspond to RBs of the PUSCH FDRA are included. In other words, the system disregards those FD units and the entries of the indicated FD bases that do not overlap with the PUSCH (e.g., FD unit M+1 in FIG. 25 and FD unit N-SRS/2 in FIG. 26).

For the embodiment of FIG. 25, the size of FD basis, i.e., N_{fd}=number of FD units, is determined based on the BW of the most recent SRS transmission used for uplink codebook transmission.

Determine N_{fd} based on RBₛₜₐᵣₜ^{SRS}, RB_{end}^{SRS} and the number of RBs per FD unit M. The SRS spans FD units 0 to N_SRS-1 in total, so N_fd=N_SRS.

The PUSCH FDRA spans FD units {1, . . . , M} and {N, . . . , O}. The n-th FD unit=FD unit n+1 if 0<=n<=M−1. The n-th FD unit=FD unit n+N−M if M<=n<=O−N+M.

N_{fd}=FDₛₜₐᵣₜ^{SRS}−FDₛₜₐᵣₜ^{SRS}+1 where FDₛₜₐᵣₜ^{SRS} and FD_{end}^{SRS} are the starting FD unit end and ending FD unit where RBₛₜₐᵣₜ^{SRS} and RB_{end}^{SRS} belong to, respectively. In this example, the SRS starts at the common RB RB0 and ends at RB2N_SRS−1. In this case, SRS BW={RB0, . . . ,RB 2N_SRS−1 }, SRS has two hops, 1st from RB0 to N_SRS−1, 2nd from RB N_SRS to 2N SRS−1, PUSCH FDRA={RB 2 . . . 2M+1, RB 2N . . . 2I+1}.

The FD units may be counted in the following manner. Option 1: the FD unit is counted from the common resource block 0, i.e., FD unit 0={ RB 0, . . . , RB M−1}, FD unit 1={RB M, . . . , RB 2M−1}, etc. Option 2: the FD unit is counted from the lowest (starting) RB index of the SRS BW, i.e., FD unit 0={RB_start, . . . , RB_start+M−1 }, FD unit 1={RB_start+M, . . . , RB_start+2M−1}, etc. in this example, Option 1 is the same as Option 2 because the SRS starts from RB 0.

The TPMI for n-th FD unit in PUSCH FDRA is based on the s(n)-th entry of the indicated FD basis, where s(n) is the position of the n-th FD unit in the range of SRS BW. The function s(n) depends on the actual PUSCH allocation. The function indicates to just disregard the FD units and their entries of the indicated FD bases that do not fall within the PUSCH FDRA. The system may construct the TPMI by skipping the entries of the indicated FD bases that fall within the gap between PUSCH segments 1902, 1903 or before the beginning of segment 1902 or after the end of segment 1903.

Thus, The TPMI for PRBs in the n-th FD unit in PUSCH FDRA is based on the s(n)=n+1 th entry of the indicated FD basis, if 0<=n<=M−1. The TPMI for PRBs in the n-th FD unit in PUSCH FDRA is based on the s(n)=n+N−M th entry of the indicated FD basis, if M<=n<=O−N+M

For the transmitted signal on the i-th PRB, the system first determines its FD unit index n(i), and secondly its TPMI is based on the s(n(i))-th entry of the indicated FD basis, e.g., fₖ_{_{p,m,l}}^{H}[s(n(i))] for the p-th port.

For the embodiment of FIG. 26, itis similar to the embodiment of FIG. 25, but the embodiment of FIG. 26 recalculates the compression for each hop of the SRS. Thus, in this example, the embodiment of FIG. 26 may be more computationally intensive and more complex than the embodiment of FIG. 25.

Continuing with FIG. 26, The size of FD basis, i.e., N_{fd}=number of FD units, is determined based on the BW of each hop of the most recent SRS transmission used for uplink codebook transmission. The PUSCH FDRA={RB 2 . . . 2M+1, RB 2N . . . 2O+1}.

The system determines N_{fd} based on RBₛₜₐᵣₜ^{SRS,j}, RB_{end}^{SRS,j} and the number of RBs per FD unit M. In this example, the index j refers to each hop of the SRS.

N_{df,j}=FDₛₜₐᵣₜ^{SRS,j}−FD_{end}^{SRS,j} where FDₛₜₐᵣₜ^{SRS,j} and FD_{end}^{SRS,j} are the starting FD unit and ending FD unit where RBₛₜₐᵣₜ^{SRS,j} and RB_{end}^{SRS,j} belong to, respectively. Thus, the starting FD unit of the first hop is FD unit 0 (beginning at RB 0) and the ending FD unit is FD unit 2 (ending at RB 5). The starting unit of the second hop is FD unit M+1 and the ending FD unit is FD unit N_SRS−1.

In some cases, the N_{fd} in different hops may be different depending on the actual number of FD units in each hop; the indicated FD bases for each hop may be also different, and the linear combination coefficients for each hop may be also different.

The FD units may be counted in the same way that they are counted in the FIG. 25 embodiment.

The TPMI for n-th FD unit in PUSCH FDRA is based on the s(n)-th entry of the indicated FD basis for SRS hop j, where s(n) is the position of the n-th FD unit in the range of j-th SRS hop.

For the transmitted signal on the i-th PRB, the UE determines its FD unit index n(i) and the SRS hop index j(i), and secondly its TPMI is based on the s(n(i))-th entry of the indicated FD basis for the j(i)-th SRS hop, e.g., fₖ_{_{p,m,l,j(i)}}^{H}[s(n(i))] for the p-th port.

The TPMI for PRBs in the n-th FD unit in PUSCH FDRA is based on the s(n)=n+1th entry of the indicated FD basis for the first hop, if 0<=n<=M−1.

The TPMI for PRBs in the n-th FD unit in PUSCH FDRA is based on the s(n)=n+N−M−N_SRS/2^{th} entry of the indicated FD basis for the second hop, if M<=n<=O−N+M.

In the embodiments described above, the size of the FD basis (N_{fd}) is based on either the PUSCH FDRA or the SRS bandwidth. However, other embodiments may use any appropriate measure to set the size of the FD basis.

In one example, the size of FD basis, i.e., N_{fd}=number of FD units, is configured by a dedicated field in downlink control information (DCI), media access control (MAC) control element (MAC CE) or RRC, and that configuration can be based on any appropriate factor or even be arbitrary.

The size-N_{fd} FD basis is applied to consecutive FD units starting from FD unit FDₛₜₐᵣₜ and ending at FD unit FD_{end}. Both FDₛₜₐᵣₜ and FD_{end} are configured by the network or derived from RBₛₜₐᵣₜ and RB_{end} which are configured by the network. In other words, one way is to have both the starting FD unit and the ending FD unit be defined by the network, and then the system derives the size of the FD basis from that. Another example includes having an explicit configuration of the size of the FD basis and either one of the starting FD or the ending FD, and in the system can derive the other one of the starting FD or the ending FD from that.

The FD units may be counted in any appropriate manner. Option 1: the FD unit is counted from the common resource block 0, i.e., FD unit 0={RB 0, . . . , RB M−1}, FD unit 1={RB M, . . . , RB 2M−1}, etc. Option 2: the FD unit is counted from the lowest (starting) RB index of the SRS BW, i.e., FD unit 0={RB_start, . . . , RB_start+M−1}, FD unit 1={RB_start+M, . . . , RB_start+2M−1}, etc. This is similar to the counting technique described above with respect to FIGS. 19-24.

The TPMI for n-th FD unit in PUSCH FDRA is may be based on the s(n)-th entry of the indicated FD basis, where s(n) is the position of the n-th FD unit in the range where the FD basis is applied. For the transmitted signal on the i-th PRB, the UE determines its FD unit index n(i), and secondly its TPMI is based on the s(n(i))-th entry of the indicated FD basis, e.g., fₖ_{_{p,m,l}}^{H}[s(n(i))] for the p-th port. In other words, those entries of the indicated FD units that do not correspond to an RB of the PUSCH FDRA may be disregarded.

In another example, the size of the FD basis may be based on a size of an uplink bandwidth part (BWP). This is similar to the embodiments of FIGS. 25 and 26, except that instead of using a size of the SRS bandwidth, the size of the FD basis is determined based on the number of RBs in the active uplink BWP on which the PUSCH is to be transmitted.

The FD units may be counted in any appropriate manner, such as the same as or similar to the technique described above with respect to FIGS. 19-22.

Once again, the TPMI for n-th FD unit in PUSCH FDRA may be based on the s(n)-th entry of the indicated FD basis. In other words, those entries of the indicated FD units that do not correspond to an RB of the PUSCH FDRA may be disregarded.

For the examples above, the size of a single FD unit has been set at two RBs, though the scope of embodiments is not so limited. In fact, the size of a single FD unit may be set at any appropriate number of RBs. In one example, the size of the FD unit (or PRG) is derived from RBG size based on a ratio O, e.g., FD unit size=O*RBGsize. Candidate values of O include {0.5, 1, 2, 4}. If O not configured, FD unit size=1RB or FD unit size=RBGsize. For the examples in FIGS. 25 and 26, if an FD unit does not fall within the SRS bandwidth, that FD unit may not be counted in N_{fd}.

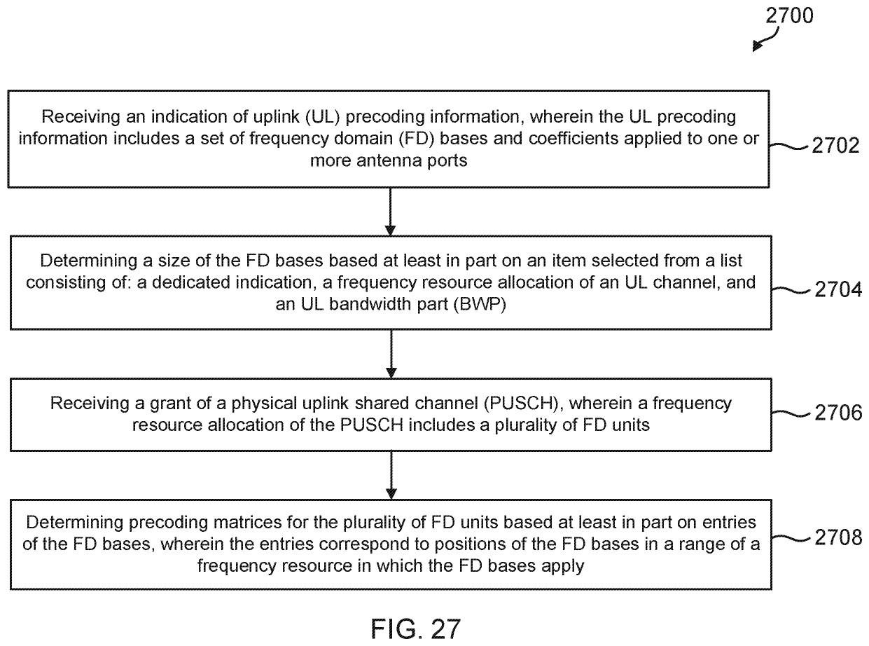

FIG. 27 is an illustration of an example method 2700, which may be performed by a UE, according to one implementation. For instance, the example method may be performed by a processor in the UE as it executes computer readable code to provide the functionality of the actions of method 2700.

At action 2702, the UE receives an indication of UL pre-coding information. In one example, the UL pre-coding information includes a set of FD bases and coefficients applied to one or more antenna ports. Examples of FD bases are described above with respect to FIGS. 16-26. The indication in action 2702 may refer to codebook entries rather than the actual bases and coefficients themselves. However, the scope of implementations does not preclude that the bases and coefficients themselves may be transmitted from the BS to the UE. For instance, the TPMI may include both of the FD basis and the coefficient for each port and each FD unit.

To use the indication received at action 2702, the UE determines a size of the FD basis and the PUSCH FDRA.

At action 2704, the UE determines a size of the FD basis (N_{fd}). The size of the FD basis may be based on any appropriate factor, including a frequency resource allocation of an uplink channel such as a size of the PUSCHFDRA, a size of the SRS bandwidth, a dedicated indication, or a size of a UL BWP.

In the example of FIGS. 19-24, the size of the FD bases is based on the PUSCH FDRA. In the examples of FIGS. 25-26, the size of the FD bases is based on the bandwidth of the SRS.

At action 2706, the UE receives a grant of a PUSCH, and the frequency resource allocation (the FDRA) of the PUSCH includes a plurality of FD units. Examples are shown in FIGS. 19-26, wherein the PUSCH FDRA, whether it is consecutive or broken into segments, corresponds to multiple FD units, and each of the FD units corresponds to one or more RBs. Some of the RBs may fall outside of the PUSCH FDRA, such as falling within a gap between PUSCH segments or starting below a first PUSCH segment or starting higher than a second PUSCH segment.

At action 2708, the UE determines pre-coding matrices for the plurality of FD units based at least in part on entries of the FD bases. For example, the UE may map the TPMI entries according to the PUSCH FDRA. Examples are described above with respect to the embodiments of FIGS. 19-26, wherein the entries correspond to positions of the FD bases in a range of the frequency resource (the PUSCH FDRA) in which the FD bases apply.

The scope of embodiments is not limited to the action shown in FIG. 27. Rather, actions may be added, omitted, rearrange, or modified as appropriate. For instance, method 2700 may further include transmitting on the uplink according to the pre-coding matrices. Also, the actions may be repeated as often as is appropriate, such as, as channel conditions change, the pre-coding matrices may be re-generated.

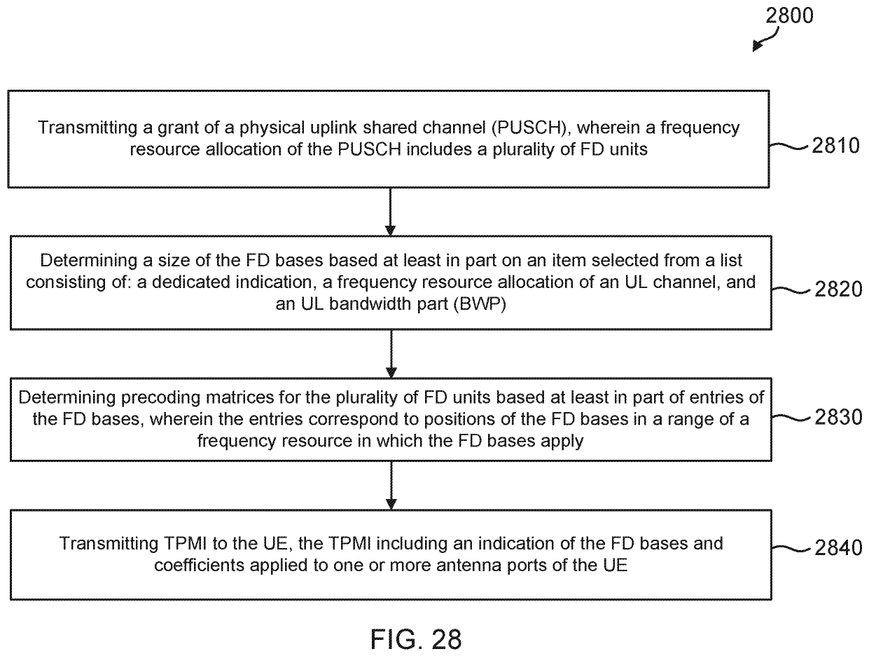

FIG. 28 is an illustration of example method 2800, which may be performed by a network entity, such as a base station, according to one implementation. Specifically, the actions of method 2800 may be performed as a processor executes computer-readable code.

At action 2810, the base station transmits a grant of a PUSCH. Action 2810 may correspond to action 2730 of method 2700, where the FDRA of the PUSCH includes a plurality of FD units.

At action 2820, the base station determines a size of the FD bases. The base station may perform such action the same as or similar to action 2720 of method 2700 above.

At action 2830, the base station determines pre-coding matrices for the plurality of FD units. At action 2830, the base station may calculate the FD bases and coefficients and map the FD bases and coefficients to FD units according to the PUSCH FDRA.

At action 2840, the base station transmits TPMI to the UE. The TPMI includes an indication of FD bases and coefficients applied to one or more antenna ports of the UE.

Reference is now made to various aspects of the present disclosure, as described below in the following numbered clauses.

1. A method of wireless communication performed by a user equipment (UE), the method comprising:
receiving an indication of uplink (UL) precoding information, wherein the UL precoding information includes a set of frequency domain (FD) bases and coefficients applied to one or more antenna ports;
determining a size of the FD bases based at least in part on an item selected from a list consisting of: a dedicated indication, a frequency resource allocation of an UL channel, and an UL bandwidth part (BWP);
receiving a grant of a physical uplink shared channel (PUSCH), wherein a frequency resource allocation of the PUSCH includes a plurality of FD units; and
determining precoding matrices for the plurality of FD units based at least in part on entries of the set of FD bases, wherein the entries correspond to positions of the FD bases in a range of a frequency resource in which the FD bases apply.

2. The method of clause 1, wherein the precoding matrices include a plurality of vectors corresponding to a plurality of sub-bands of the UL channel, each vector of the plurality of vectors providing amplitude and phase quantization data for the one or more antenna ports.

3. The method of clauses 1-2, wherein the frequency resource allocation of the UL channel corresponds to the frequency resource allocation of the PUSCH, and wherein the size of the FD bases is equal to a number of FD units in the frequency resource allocation of the PUSCH, and wherein the entries of the set of FD bases within the precoding matrices are based at least in part on an order of the FD units in the frequency resource allocation of the PUSCH.

4. The method of clause 3, wherein the order of the FD units is based on an index that is counted from a common resource block or is counted from a first resource block of the frequency resource allocation of the PUSCH.

5. The method of clauses 1-2, wherein the frequency resource allocation of the UL channel corresponds to the frequency resource allocation of the PUSCH, wherein the size of the FD bases is determined based on a lowest resource block index and a highest resource block index of the frequency resource allocation of the PUSCH, and wherein the entries of the set of FD bases within the precoding matrices are based on an order of the FD units from the lowest resource block index to the highest resource block index.

6. The method of clause 5, wherein the order of the FD units is based on an index that is counted from a common resource block or is counted from the lowest resource block index.

7. The method of clauses 1-2, wherein the frequency resource allocation of the UL channel corresponds to the frequency resource allocation of the PUSCH, and wherein determining the size of the FD bases includes:
determining that the PUSCH comprises a plurality of segments;
receiving a first set of FD bases for a first segment and a second set of FD bases for a second segment; and
determining the FD bases size of the first set of FD bases based on a number of resource blocks or FD units in the first segment;
wherein the entries of the set of FD bases within the precoding matrices are based on an order of the FD units in the first segment and the second segment.

8. The method of clause 7, wherein the order of the FD units is based on an index that is counted from a common resource block or is counted from a starting resource block of the first segment and a starting resource block of the second segment.

9. The method of clauses 1-2, wherein the frequency resource allocation of the UL channel corresponds to a frequency resource allocation of a sounding reference signal (SRS), wherein determining the FD bases size is based at least in part on a lowest resource block index and a highest resource block index of the SRS, and wherein the entries of the set of FD bases within the precoding matrices are based on an order of the FD units starting from the lowest resource block index and ending at the highest resource block index.

10. The method of clause 9, wherein the order of the FD units is based on an index that is counted from a common resource block or is counted from a starting resource block of the SRS.

11. The method of clauses 1-2, wherein the frequency resource allocation of the UL channel corresponds to a frequency resource allocation of a sounding reference signal (SRS), and wherein determining the size of the FD bases includes:
determining that the SRS comprises a plurality of segments;
receiving a first set of FD bases for a first segment and a second set of FD bases for a second segment; and
determining the FD bases size of the first set of FD bases based on a number of resource blocks or FD units in the first segment;
wherein the entries of the set of FD bases within the precoding matrices are based on an order of the FD units in the first segment and the second segment.

12. The method of clause 11, wherein the order of the FD units is based on an index that is counted from a common resource block or is counted from a starting resource block of the first segment and a starting resource block of the second segment.

13. The method of clauses 1-2, wherein the size of the FD bases is based at least in part on the dedicated indication, and wherein the dedicated indication includes an item selected from a list consisting of:
a first resource block index and a second resource block index, wherein the size of the FD bases corresponds to a difference between the first resource block index and the second resource block index;
an explicit FD bases size and a starting resource block index; and
a starting resource block index or an ending resource block index that is determined based on the PUSCH or on a sounding reference signal (SRS).

14. The method of clause 13, wherein an order of the FD units starts from the first resource block index and ends at the second resource block index.

15. The method of clauses 1-2, wherein the size of the FD bases is based on a size of the UL BWP, wherein determining the size of the FD bases is based at least in part on a lowest resource block index and a highest resource block index of the BWP, and wherein an order of the entries of the set of FD bases within the precoding matrices is based on an order of the FD units starting from the lowest resource block index and ending at the highest resource block index.

16. The method of clause 15, wherein the order of the FD units is based on an index that is counted from a common resource block or is counted from a starting resource block of the BWP.

17. The method of clauses 1-16, wherein each FD unit comprises one or more resource blocks, wherein each FD unit size is equal to a size of a resource block group or is equal to a scaled size of a resource block group.

18. A non-transitory computer-readable medium having program code recorded thereon for wireless communication by a user equipment (UE), the program code comprising:
code for receiving a set of frequency domain (FD) bases and coefficients corresponding to one or more antenna ports of the UE;
code for determining a size of the FD bases based at least in part on an item selected from a list consisting of: a dedicated indication, a frequency resource allocation of an UL channel, and an UL bandwidth part (BWP); and
code for determining precoding matrices for a plurality of FD units in a physical uplink shared channel (PUSCH) based at least in part on entries of the set of FD bases, wherein the entries correspond to positions of the FD bases in a range of a frequency resource in which the FD bases apply.

19. The non-transitory computer-readable medium of clause 18, wherein the frequency resource allocation of the UL channel corresponds to the frequency resource allocation of the PUSCH, and wherein the size of the FD bases is equal to a number of FD units in the frequency resource allocation of the PUSCH, and wherein the entries of the set of FD bases within the precoding matrices are based at least in part on an order of the FD units in the frequency resource allocation of the PUSCH.

20. The non-transitory computer-readable medium of clause 18, wherein the frequency resource allocation of the UL channel corresponds to the frequency resource allocation of the PUSCH, wherein the size of the FD bases is determined based on a lowest resource block index and a highest resource block index of the frequency resource allocation of the PUSCH, and wherein the entries of the set of FD bases within the precoding matrices are based on an order of the FD units from the lowest resource block index to the highest resource block index.

21. The non-transitory computer-readable medium of clause 18, wherein the frequency resource allocation of the UL channel corresponds to the frequency resource allocation of the PUSCH, and wherein the code for determining the size of the FD bases includes:
code for determining that the PUSCH comprises a plurality of segments;
code for receiving a first set of FD bases for a first segment and a second set of FD bases for a second segment; and
code for determining the FD bases size of the first set of FD bases based on a number of resource blocks or FD units in the first segment;
wherein the entries of the set of FD bases within the precoding matrices are based on an order of the FD units in the first segment and the second segment.

22. The non-transitory computer-readable medium of clause 18, wherein the frequency resource allocation of the UL channel corresponds to a frequency resource allocation of a sounding reference signal (SRS), wherein determining the FD bases size is based at least in part on a lowest resource block index and a highest resource block index of the SRS, and wherein the entries of the set of FD bases within the precoding matrices are based on an order of the FD units starting from the lowest resource block index and ending at the highest resource block index.

23. The non-transitory computer-readable medium of clause 18, wherein the size of the FD bases is based at least in part on the dedicated indication, and wherein the dedicated indication includes an item selected from a list consisting of:
a first resource block index and a second resource block index, wherein the size of the FD bases corresponds to a difference between the first resource block index and the second resource block index;
an explicit FD bases size and a starting resource block index; and a starting resource block index or an ending resource block index that is determined based on the PUSCH or on a sounding reference signal (SRS).

24. The non-transitory computer-readable medium of clause 18, wherein the size of the FD bases is based on a size of the UL BWP, wherein determining the size of the FD bases is based at least in part on a lowest resource block index and a highest resource block index of the BWP, and wherein an order of the entries of the set of FD bases within the precoding matrices is based on an order of the FD units starting from the lowest resource block index and ending at the highest resource block index.

25. A user equipment (UE) comprising:
means for receiving, from a network entity, information indicating a plurality of frequency domain (FD) bases and linear combination coefficients;
means for receiving a grant of a physical uplink shared channel (PUSCH), wherein a frequency resource allocation of the PUSCH includes a plurality of FD units; and
means for determining subband precoding based at least in part on linear combinations of the FD bases, wherein the subband precoding maps PUSCH layers to antenna ports of the UE, including determining a precoding matrix for each FD unit based on a respective entry of the FD bases, wherein the respective entry is determined based on a position of a corresponding FD basis within a range of a frequency resource of the plurality of FD bases; and
means for transmitting the PUSCH with the subband pre-coding.

26. The UE of clause 25, further comprising:
means for determining a size of the FD bases based at least in part on an item selected from a list consisting of: a dedicated indication, a frequency resource allocation of an UL channel, and an UL bandwidth part (BWP);

27. The UE of clause 26, wherein the size of the FD bases is determined based on a lowest resource block index and a highest resource block index of the frequency resource allocation of the PUSCH, and wherein entries of the FD bases within the subband precoding are based on an order of the FD units from the lowest resource block index to the highest resource block index.

28. A user equipment (UE) comprising:
a processor configured to execute machine-readable instructions to perform a method that includes:
receiving, from a network entity, information indicating a plurality of frequency domain (FD) bases and linear combination coefficients;
receiving a grant of a physical uplink shared channel (PUSCH), wherein a frequency resource allocation of the PUSCH includes a plurality of FD units; and
determining subband precoding based at least in part on linear combinations of the FD bases, wherein the subband precoding maps PUSCH layers to antenna ports of the UE, including determining a pre-coding matrix for each FD unit based on a respective entry of the FD bases, wherein the respective entry is determined based on a position of a corresponding FD basis within a range of a frequency resource of the plurality of FD bases; and
transmitting the PUSCH with the subband pre-coding.

29. The UE of clause 28, wherein the processor is further configured to execute machine-readable instructions to perform:
determining a size of the FD bases based at least in part on an item selected from a list consisting of: a dedicated indication, a frequency resource allocation of an UL channel, and an UL bandwidth part (BWP);

30. The UE of clause 29, wherein the size of the FD bases is determined based on a lowest resource block index and a highest resource block index of the frequency resource allocation of the PUSCH, and wherein entries of the FD bases within the subband precoding are based on an order of the FD units from the lowest resource block index to the highest resource block index.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, the various processor shown in FIG. 3 may be configured to perform operations 800 and 900 of FIGS. 8 and 9.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a UE 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 13 and 14).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of wireless communication performed by a user equipment (UE), the method comprising:
receiving an indication of uplink (UL) precoding information, wherein the UL precoding information includes a set of frequency domain (FD) bases and coefficients applied to one or more antenna ports;
determining a size of the FD bases based at least in part on an item selected from a list consisting of: a dedicated indication, a frequency resource allocation of an UL channel, and an UL bandwidth part (BWP);
receiving a grant of a physical uplink shared channel (PUSCH), wherein a frequency resource allocation of the PUSCH includes a plurality of FD units; and
determining precoding matrices for the plurality of FD units based at least in part on entries of the set of FD bases, wherein the entries correspond to positions of the FD bases in a range of a frequency resource in which the FD bases apply.

2. The method of claim 1, wherein the precoding matrices include a plurality of vectors corresponding to a plurality of sub-bands of the UL channel, each vector of the plurality of vectors providing amplitude and phase quantization data for the one or more antenna ports.

3. The method of claim 1, wherein the frequency resource allocation of the UL channel corresponds to the frequency resource allocation of the PUSCH, and wherein the size of the FD bases is equal to a number of FD units in the frequency resource allocation of the PUSCH, and wherein the entries of the set of FD bases within the precoding matrices are based at least in part on an order of the FD units in the frequency resource allocation of the PUSCH.

4. The method of claim 3, wherein the order of the FD units is based on an index that is counted from a common resource block or is counted from a first resource block of the frequency resource allocation of the PUSCH.

5. The method of claim 1, wherein the frequency resource allocation of the UL channel corresponds to the frequency resource allocation of the PUSCH, wherein the size of the FD bases is determined based on a lowest resource block index and a highest resource block index of the frequency resource allocation of the PUSCH, and wherein the entries of the set of FD bases within the precoding matrices are based on an order of the FD units from the lowest resource block index to the highest resource block index.

6. The method of claim 5, wherein the order of the FD units is based on an index that is counted from a common resource block or is counted from the lowest resource block index.

7. The method of claim 1, wherein the frequency resource allocation of the UL channel corresponds to the frequency resource allocation of the PUSCH, and wherein determining the size of the FD bases includes:
determining that the PUSCH comprises a plurality of segments;
receiving a first set of FD bases for a first segment and a second set of FD bases for a second segment; and
determining the FD bases size of the first set of FD bases based on a number of resource blocks or FD units in the first segment;
wherein the entries of the set of FD bases within the precoding matrices are based on an order of the FD units in the first segment and the second segment.

8. The method of claim 7, wherein the order of the FD units is based on an index that is counted from a common resource block or is counted from a starting resource block of the first segment and a starting resource block of the second segment.

9. The method of claim 1, wherein the frequency resource allocation of the UL channel corresponds to a frequency resource allocation of a sounding reference signal (SRS), wherein determining the FD bases size is based at least in part on a lowest resource block index and a highest resource block index of the SRS, and wherein the entries of the set of FD bases within the precoding matrices are based on an order of the FD units starting from the lowest resource block index and ending at the highest resource block index.

10. The method of claim 9, wherein the order of the FD units is based on an index that is counted from a common resource block or is counted from a starting resource block of the SRS.

11. The method of claim 1, wherein the frequency resource allocation of the UL channel corresponds to a frequency resource allocation of a sounding reference signal (SRS), and wherein determining the size of the FD bases includes:
determining that the SRS comprises a plurality of segments;
receiving a first set of FD bases for a first segment and a second set of FD bases for a second segment; and
determining the FD bases size of the first set of FD bases based on a number of resource blocks or FD units in the first segment;
wherein the entries of the set of FD bases within the precoding matrices are based on an order of the FD units in the first segment and the second segment.

12. The method of claim 11, wherein the order of the FD units is based on an index that is counted from a common resource block or is counted from a starting resource block of the first segment and a starting resource block of the second segment.

13. The method of claim 1, wherein the size of the FD bases is based at least in part on the dedicated indication, and wherein the dedicated indication includes an item selected from a list consisting of:
a first resource block index and a second resource block index, wherein the size of the FD bases corresponds to a difference between the first resource block index and the second resource block index;
an explicit FD bases size and a starting resource block index; and
a starting resource block index or an ending resource block index that is determined based on the PUSCH or on a sounding reference signal (SRS).

14. The method of claim 13, wherein an order of the FD units starts from the first resource block index and ends at the second resource block index.

15. The method of claim 1, wherein the size of the FD bases is based on a size of the UL BWP, wherein determining the size of the FD bases is based at least in part on a lowest resource block index and a highest resource block index of the BWP, and wherein an order of the entries of the set of FD bases within the precoding matrices is based on an order of the FD units starting from the lowest resource block index and ending at the highest resource block index.

16. The method of claim 15, wherein the order of the FD units is based on an index that is counted from a common resource block or is counted from a starting resource block of the BWP.

17. The method of claim 1, wherein each FD unit comprises one or more resource blocks, wherein each FD unit size is equal to a size of a resource block group or is equal to a scaled size of a resource block group.

18. A non-transitory computer-readable medium having program code recorded thereon for wireless communication by a user equipment (UE), the program code comprising:
code for receiving a set of frequency domain (FD) bases and coefficients corresponding to one or more antenna ports of the UE;
code for determining a size of the FD bases based at least in part on an item selected from a list consisting of: a dedicated indication, a frequency resource allocation of an UL channel, and an UL bandwidth part (BWP); and
code for determining precoding matrices for a plurality of FD units in a physical uplink shared channel (PUSCH) based at least in part on entries of the set of FD bases, wherein the entries correspond to positions of the FD bases in a range of a frequency resource in which the FD bases apply.

19. The non-transitory computer-readable medium of claim 18, wherein the frequency resource allocation of the UL channel corresponds to the frequency resource allocation of the PUSCH, and wherein the size of the FD bases is equal to a number of FD units in the frequency resource allocation of the PUSCH, and wherein the entries of the set of FD bases within the precoding matrices are based at least in part on an order of the FD units in the frequency resource allocation of the PUSCH.

20. The non-transitory computer-readable medium of claim 18, wherein the frequency resource allocation of the UL channel corresponds to the frequency resource allocation of the PUSCH, wherein the size of the FD bases is determined based on a lowest resource block index and a highest resource block index of the frequency resource allocation of the PUSCH, and wherein the entries of the set of FD bases within the precoding matrices are based on an order of the FD units from the lowest resource block index to the highest resource block index.

21. The non-transitory computer-readable medium of claim 18, wherein the frequency resource allocation of the UL channel corresponds to the frequency resource allocation of the PUSCH, and wherein the code for determining the size of the FD bases includes:
code for determining that the PUSCH comprises a plurality of segments;
code for receiving a first set of FD bases for a first segment and a second set of FD bases for a second segment; and
code for determining the FD bases size of the first set of FD bases based on a number of resource blocks or FD units in the first segment;
wherein the entries of the set of FD bases within the precoding matrices are based on an order of the FD units in the first segment and the second segment.

22. The non-transitory computer-readable medium of claim 18, wherein the frequency resource allocation of the UL channel corresponds to a frequency resource allocation of a sounding reference signal (SRS), wherein determining the FD bases size is based at least in part on a lowest resource block index and a highest resource block index of the SRS, and wherein the entries of the set of FD bases within the precoding matrices are based on an order of the FD units starting from the lowest resource block index and ending at the highest resource block index

23. The non-transitory computer-readable medium of claim 18, wherein the size of the FD bases is based at least in part on the dedicated indication, and wherein the dedicated indication includes an item selected from a list consisting of:
a first resource block index and a second resource block index, wherein the size of the FD bases corresponds to a difference between the first resource block index and the second resource block index;
an explicit FD bases size and a starting resource block index; and
a starting resource block index or an ending resource block index that is determined based on the PUSCH or on a sounding reference signal (SRS).

24. The non-transitory computer-readable medium of claim 18, wherein the size of the FD bases is based on a size of the UL BWP, wherein determining the size of the FD bases is based at least in part on a lowest resource block index and a highest resource block index of the BWP, and wherein an order of the entries of the set of FD bases within the precoding matrices is based on an order of the FD units starting from the lowest resource block index and ending at the highest resource block index.

25. A user equipment (UE) comprising:
means for receiving, from a network entity, information indicating a plurality of frequency domain (FD) bases and linear combination coefficients;
means for receiving a grant of a physical uplink shared channel (PUSCH), wherein a frequency resource allocation of the PUSCH includes a plurality of FD units; and
means for determining subband precoding based at least in part on linear combinations of the FD bases, wherein the subband precoding maps PUSCH layers to antenna ports of the UE, including determining a precoding matrix for each FD unit based on a respective entry of the FD bases, wherein the respective entry is determined based on a position of a corresponding FD basis within a range of a frequency resource of the plurality of FD bases; and
means for transmitting the PUSCH with the subband pre-coding.

26. The UE of claim 25, further comprising:
means for determining a size of the FD bases based at least in part on an item selected from a list consisting of: a dedicated indication, a frequency resource allocation of an UL channel, and an UL bandwidth part (BWP);

27. The UE of claim 26, wherein the size of the FD bases is determined based on a lowest resource block index and a highest resource block index of the frequency resource allocation of the PUSCH, and wherein entries of the FD bases within the subband precoding are based on an order of the FD units from the lowest resource block index to the highest resource block index.

28. A user equipment (UE) comprising:
a processor configured to execute machine-readable instructions to perform a method that includes:
receiving, from a network entity, information indicating a plurality of frequency domain (FD) bases and linear combination coefficients;
receiving a grant of a physical uplink shared channel (PUSCH), wherein a frequency resource allocation of the PUSCH includes a plurality of FD units; and
determining subband precoding based at least in part on linear combinations of the FD bases, wherein the subband precoding maps PUSCH layers to antenna ports of the UE, including determining a pre-coding matrix for each FD unit based on a respective entry of the FD bases, wherein the respective entry is determined based on a position of a corresponding FD basis within a range of a frequency resource of the plurality of FD bases; and
transmitting the PUSCH with the subband pre-coding.

29. The UE of claim 28, wherein the processor is further configured to execute machine-readable instructions to perform:
determining a size of the FD bases based at least in part on an item selected from a list consisting of: a dedicated indication, a frequency resource allocation of an UL channel, and an UL bandwidth part (BWP);

30. The UE of claim 29, wherein the size of the FD bases is determined based on a lowest resource block index and a highest resource block index of the frequency resource allocation of the PUSCH, and wherein entries of the FD bases within the subband precoding are based on an order of the FD units from the lowest resource block index to the highest resource block index.
